(19) United States
(12) Patent Application Publication
(10) Pub. No.: US 2014/0339296 A1
(43) Pub. Date: Nov. 20, 2014

(54) Barcode, barcode device, system, and method

(71) Applicants: John B. McAdams, Lauderdale by the Sea, FL (US); William L. Klima, Fredericksburg, VA (US)

(72) Inventors: John B. McAdams, Lauderdale by the Sea, FL (US); William L. Klima, Fredericksburg, VA (US)

(21) Appl. No.: 13/986,626

(22) Filed: May 20, 2013

(51) Int. Cl. G06F 17/30

(52) U.S. Cl. CPC G06F 17/30; G06F 17/3074
USPC 235/375

(57) ABSTRACT

A barcode device including a barcode scanning device and a cell phone. The barcode scanning device can be a contact or non-contact or near contact barcode scanning device.

### RELATED APPLICATIONS

This application is a continuation-in-part (CIP) of continuation U.S. patent application entitled “BRAILLE TYPE DEVICE, SYSTEM, AND METHOD”, application Ser. No. 12/073,808, filed on Mar. 10, 2008, and U.S. patent application entitled “BRAILLE TYPE DEVICE, SYSTEM, AND METHOD”, application Ser. No. 10/808,456, filed on Mar. 25, 2004, both applications being fully incorporated by reference herein.

### FIELD

The present invention is directed to a barcode, barcode device, barcode system, barcode method, barcode voice, barcode speech, barcode speech device, barcode language, barcode cell phone, barcode memory, barcode transmission, and data in barcode format. For example, barcode devices and barcode speech devices according to the present invention comprise telephones, cell phones, smart phones, e-pads, e-readers, personal computers, computer mouses, and other personal electronic devices or personal computer devices.

In particular, the present invention is directed to a telephone device, system, and method, in particular a cell phone or smart phone configured to covert barcode into a voice, speech, and/or a language. The barcode is a machine-readable bar code, for example, in particular a high density two-dimensional matrix bar code printed on a medium, containing the information content shown on the medium (i.e. printed matter) or a barcode shown on a display. The printed matter, for example, can be documents, books, publications, magazines, reading materials, literature, brochures, memos, notes, journals, newspapers, money, stamps, bills, and all types of other printed matter supported by a medium, for example, paper, cardboard, plastic, film, metal, glass, ceramic, or displayed on a screen, for example, cathode ray tube (CRT), liquid crystal display (LCD), plasma screen, Interferometric modulated screens, in plane switching displays, and e ink technologies for example. The telephone device includes a barcode scanning and/or reading device, preferably configured to scan and/or read the barcode and provide an audio output, preferably a computer voice or speech, and/or language(s). The telephone method involves the step of scanning and/or reading a barcode, and converting same into a voice, or speech.

The present invention is also directed to a barcode device, system, and method. The barcode device includes printed matter in combination with barcode according to the present invention, in particular machine-readable barcode according to the present invention. The printed matter, for example, can be books, publications, reading materials, literature, brochures, memos, notes, journals, newspapers, and all type of other printed matter supported by a medium, for example, paper, cardboard, plastic, metal, glass, ceramic. The Braille type system includes the Braille type device according to the present invention in combination with a Braille type scanning device, in particular a portable handheld Braille type scanning device, preferably configured to read the Braille type code according to the present invention and provide an audio output, preferably a computer voice or speech. The Braille type method involves a printing method for printing Braille type code according to the present invention on a substrate suitable for supporting printed matter.

### BACKGROUND

Only a couple of centuries ago, a person born blind or becoming blind during their lifetime suffered a major disability with little hope for becoming a productive person. There existed no means or technology to allow a blind person to read on their own, and thus such persons relied mainly on hearing, speech, and touch for interacting with the surrounding world. During the Napoleonic Wars, a system was created to allow a military personal, to read a secret code by their finger tips for the purpose of receiving information for spatial coordinates for aiming and shooting artillery at night, to avoid the use of light for visual reading of such information. Prior visual reading with light, proved to be a significant problem, since the enemy could easily aim and fire at the illuminated target. Eventually, this code became modified to be used by the blind and was named after the inventor Braille.

Since the time when Louis Braille introduced his modified military tactile code as a communication means for the blind in 1829, very little has been done to provide an alternative “language” for the low vision or blind (LV/B) persons. In the times of Helen Keller, there were approximately 250,000 Braille-literate people in the United States. Today, there are only approximately 85,000 Braille-literate people in the United States. Of children (K thru 12) in the United States, only approximately 5,500 can read Braille. There is, however, no new language for the LV/B individuals to free them from either Braille, or other expensive sophisticated devices that may or may not make their lives easier. Most of these devices, which use Braille as their language are both cumbersome and expensive. Others require some vision such as enlarged print.

Braille is a pattern of raised dots or bumps in a particular pattern to symbolize an alphanumeric letter, thus a different pattern exists for each letter of the alphabet or number. A person reading the code places his or her finger tip of the index finger of their reading hand over the Braille, and begins to read left to right, top to bottom. Braille is a relatively difficult system to learn and use, since it is extremely difficult for a person to acquire the sensitivity or ability to accurately feel the raised dots or bumps to an extent to be able to interpret and understand each particular letter.

Today, being blind is still a significant disability substantially inhibiting employment, daily activities, and hampering personal and professional productivity. This significant disability renders most of such blind persons unable to function successfully in today's advance computer based work environments, and thus most are unemployable, even in service industries, despite most blind person's desire to work and live like the rest of the population.

There exists a substantial need to devise a new device, system, and method to provide most blind persons to read printed matter at a level to allow such blind persons to work and compete successfully in a job environment. In 2002-2004, Congress enacted the Instructional Materials Accessibility Act requiring publishers of printed matters in the United States to devise such a device, system, or method to allow blind persons to obtain the same information contained in published printed matter, simultaneously with sighted. The present invention provides such means to allow dissemination of printed matter or published information to the blind.

Further, there exists millions of illiterate and/or handicapped persons (e.g. elders) that are unable to read due to never being taught to read and/or loss of physical and/or cognitive abilities. These people too need a new device, system, and method to allow them to read printed matter at a level to allow such illiterate and/or handicapped persons to work and compete successfully in a job environment. These same illiterate persons need a new device, system, and method to allow them to learn to read and/or practice reading to enhance their reading abilities.

### SUMMARY

A first object is to provide a voice or speech barcode according to the present invention.

A second object is to provide a barcode configured to be converted into a voice or speech.

A third object is to provide a barcode comprising or consisting of information configured to be converted into a voice or speech.

A fourth object is to provide a barcode comprising or consisting of information content and configured to be converted into a voice or speech.

A fifth object is to provide a barcode comprising or consisting of information configured to be converted into language.

A sixth object is to provide a barcode comprising or consisting of information configured to be converted into a foreign language.

A seventh object is to provide a barcode comprising or consisting of information configured to be converted into different foreign languages.

An eighth object is to provide a barcode configured to convert one language into another language.

A ninth object is to provide a barcode encrypted with a voice, speech, and/or language.

A tenth object is to provide a barcode encrypted to restrict access to information content stored in the barcode to be converted into a voice, speech, and/or language.

An eleventh object is to provide a barcode configured to provide a dialect of a language.

A twelfth object is to provide a barcode configured to provide multiple dialects of a language.

A thirteenth object is to provide a barcode comprising or consisting of an arrangement of marks configured to be converted into a voice or speech.

A fourteenth object is to provide a barcode comprising or consisting of information configured to be converted into speech information.

A fifteenth object is to provide a barcode comprising or consisting of information configured to be converted into digital information.

A sixteenth object is to provide a barcode comprising or consisting of information configured to be converted into digital speech information.

A seventeenth object is to provide a barcode comprising or consisting of voice or speech information.

An eighteenth object is to provide a barcode comprising or consisting of voice or speech equivalent information.

A nineteenth object is to provide a barcode comprising or consisting of text equivalent information configured to be converted into voice or speech.

A twentieth object is to provide a barcode comprising or consisting of illustration equivalent information configured to be converted into voice or speech.

A twenty first object is to provide a barcode comprising or consisting of pictorial equivalent information configured to be converted into voice or speech.

A twenty second object is to provide a barcode comprising or consisting of image equivalent information configured to be converted into voice or speech.

A twenty third object is to provide a barcode comprising or consisting of text, illustration, pictorial, and image equivalent information configured to be converted into voice or speech.

A twenty four object is to provide a barcode device comprising or consisting of information and at least one barcode printed on a medium.

A twenty fifth object is to provide a barcode device comprising or consisting of a medium comprising printed or displayed information and at least one barcode.

A twenty sixth object is to provide a barcode device comprising or consisting of a medium comprising printed or displayed information and at least one barcode, the barcode containing at least a portion of the information printed or displayed on the medium.

A twenty seventh object is to provide a barcode device comprising or consisting of a medium comprising printed or displayed information and at least one barcode, the barcode containing the same information printed or displayed on the medium.

A twenty eighth object is to provide a barcode device comprising or consisting of a medium comprising printed or displayed information and at least one barcode, the barcode containing at least a portion of the information printed or displayed on the medium and additional information.

A twenty ninth object is to provide a barcode device comprising or consisting of a medium comprising printed or displayed information and at least one barcode, the barcode containing different information compared with the information printed or displayed on the medium.

A thirtieth object is to provide a barcode device comprising or consisting of information printed or displayed on a medium in combination with at least one machine-readable barcode printed or displayed on the medium.

A thirty first object is to provide a barcode device comprising or consisting of information printed or displayed on a medium, a barcode printed or displayed on the medium, and an electronic device configured to scan the barcode and output an audio signal.

A thirty second object is to provide a barcode device comprising or consisting of information printed or displayed on a medium, a barcode printed or displayed on the medium, and an electronic device configured to scan the barcode and output a voice or speech.

A thirty third object is to provide a barcode device comprising or consisting of a barcode configured to provide an audio speech or voice when scanning the barcode.

A thirty fourth object is to provide a barcode system comprising or consisting of a barcode device according to the present invention and a barcode scanning device according to the present invention.

A thirty fifth object is to provide a barcode system comprising or consisting of a barcode according to the present invention printed or displayed on a medium, and a barcode scanning device according to the present invention.

A thirty sixth object is to provide a barcode system comprising or consisting of a barcode device comprising information printed or displayed on a medium, and a barcode scanning device according to the present invention.

A thirty seventh object is to provide a barcode system comprising or consisting of information printed or displayed on a medium, and an electronic barcode scanning device configured to provide a voice or speech.

A thirty eighth object is to provide a barcode method comprising or consisting of converting barcode into an audio voice or speech.

A thirty ninth object is to provide a barcode method comprising or consisting of converting speech into barcode.

A fortieth object is to provide a barcode method comprising or consisting of converting speech into barcode, and converting the barcode into speech.

A forty first object is to provide a barcode method comprising or consisting of converting speech in one language into barcode, and converting the barcode into speech in a different language.

A forty second object is to provide a barcode method comprising or consisting of printing or displaying information and a barcode on a medium.

A forty third object is to provide a barcode method comprising or consisting of printing or displaying a barcode on a medium, the barcode configured to provide an audio voice or speech.

A forty fourth object is to provide a barcode method comprising or consisting of printing or displaying a barcode on a medium, the barcode configured to provide an audio voice or speech when scanned with an electronic device configured to covert the barcode into an audio voice or speech.

A forty fifth object is to provide a barcode method comprising or consisting of printing or displaying information and a barcode on a medium, the barcode containing at least a portion of the information printed or displayed on the medium.

A forty sixth object is to provide a barcode method comprising or consisting of printing or displaying information printed or displayed on the medium, the barcode containing at least a portion of the information printed or displayed on the medium, and scanning the barcode with an electronic device configured to convert the barcode into a voice or speech.

A forty seventh object is to provide a barcode method comprising or consisting of printing or displaying information on a medium, printing or displaying a barcode on the medium, and scanning the barcode with an electronic device configured to convert the barcode into a voice or speech.

A forty eighth object is to provide a barcode method comprising or consisting of printing or displaying information on a medium, and printing or displaying a barcode on the medium, the barcode configured with the information printed or displayed on the medium.

A forty ninth object is to provide a barcode method comprising or consisting of printing or displaying information and a barcode onto a medium.

A fiftieth object is to provide a barcode method comprising or consisting of printing or displaying information and a barcode on a medium, the barcode configured with a least a portion of the information printed onto the medium.

A fifty first object is to provide a barcode method comprising or consisting of printing or displaying a barcode on a medium, the barcode configured to be converted into a voice or speech.

A fifty second object is to provide a barcode method comprising or consisting of printing or displaying a barcode on a medium, and scanning the barcode with an electronic device to provide a voice or speech.

A fifty third object is to provide a barcode method comprising or consisting of printing or displaying information and a barcode on a medium, the barcode configured with at least a portion of the information printed or displayed on the medium, and scanning the barcode with an electronic device to provide a voice or speech.

A fifty fourth object is to provide an improved telephone device.

A fifty fifth object is to provide a telephone device configured for scanning and/or reading a barcode.

A fifty sixth object is to provide a telephone device configured for scanning and/or reading barcode containing information content.

A fifty seventh object is to provide a telephone device configured for scanning and/or reading a barcode containing indicia information content.

A fifty eighth object is to provide a telephone device configured for scanning and/or reading barcode containing text information content.

A fifty ninth object is to provide a telephone device configured for scanning and/or reading bar code containing pictorial information content.

A sixtieth object is to provide a telephone device configured for scanning and/or reading barcode containing design information content.

A sixty first object is to provide a telephone device configured for scanning and/or reading a barcode containing video content.

A sixty second object is to provide a telephone device configured for scanning and/or reading barcode, and converting the bar code into an output signal.

A sixty third object is to provide a telephone device configured for scanning and/or reading a barcode printed or displayed on a medium, the barcode containing at least a portion of the information content printed or displayed on the medium.

A sixty fourth object is to provide a telephone device configured for scanning and/or reading a bar code printed on a medium having more information content than information content printed or displayed on the medium.

A sixty fifth object is to provide a telephone device configured for scanning and/or reading a barcode configured to be a hyperlink to at least one website.

A sixty sixth object is to provide a telephone device configured for scanning and/or reading a barcode configured to contain information content that can be converted into a voice or speech, and is also hyperlink to at least one website.

A sixty seventh object is to provide an improved telephone device configured for scanning and/or reading barcode, and converting the barcode into speech or a voice.

A sixty eighth object is to provide a telephone device configured for scanning and/or reading barcode containing information, and converting the information content of the barcode into a voice or speech and visually displaying the information as text, illustrations, pictures, and/or images.

A sixty ninth object is to provide a telephone device configured for scanning and/or reading barcode, and communicating the information stored in the barcode.

A seventieth object is to provide a telephone device configured for scanning and/or reading barcode, communicating the information stored in the barcode, and converting the communicated information into speech or a voice.

A seventy first object is to provide a telephone device configured to receive speech from a user and convert the speech into another language using a barcode intermediary.

A seventy second object is to provide a telephone device configured to receive speech from a user, convert the speech into another language using a barcode intermediary, and communicating the converted speech to the user or another person.

A seventy third object is to provide a telephone device configured to receive speech from a user, and convert the speech into a barcode.

A seventy fourth object is to provide a telephone device configured for scanning and/or reading a barcode containing the digital equivalent to printed matter on the medium.

A seventy fifth object is to provide a telephone system comprising or consisting of a telephone device configured for reading a barcode from a medium or display having at least a portion of information printed or displayed on the medium or display.

A seventy fifth object is to provide a telephone system comprising or consisting of a telephone device configured for reading a barcode from a medium or display having at least a portion of information printed or displayed on the medium or display.

A seventy sixth object is to provide a telephone system comprising or consisting of a telephone device configured for reading a barcode from a medium or display having at least a portion of information printed or displayed on the medium or display and also configured as a hyperlink to one or more websites.

A seventy seventh object is to provide a telephone system comprising or consisting of a telephone device configured for scanning and/or reading a first barcode printed or displayed on a medium, the barcode having at least a portion of the information displayed on the medium or display, and a second barcode printed or displayed on the medium configured as a hyperlink for connecting the telephone device to one or more websites.

A seventy eighth object is to provide a telephone system comprising or consisting of a telephone device and a medium displaying printed or displayed information and a barcode containing at least a portion of the printed or displayed information, the barcode being configured to be scanned and/or read by the telephone device.

A seventy ninth object is to provide a telephone system comprising or consisting of a telephone device and a medium having information printed or displayed thereon, the telephone device being configured to scan and/or read the barcode and output an audio signal.

A eightieth object is to provide a telephone system comprising or consisting of a telephone device and a display having information displayed thereon, the telephone device being configured to scan and/or read the barcode and output a machine voice or speech.

A eighty first object is to provide a telephone system comprising or consisting of a telephone device and a medium having information and a barcode printed or displayed thereon, the barcode configured to provide a voice or speech when scanning or reading the barcode with the telephone device.

An eighty second object is to provide a telephone system comprising or consisting of a telephone device configured with a barcode scanning and/or reading device according to the present invention.

An eighty third object is to provide a telephone method comprising or consisting of reading a barcode printed on a medium containing at least a portion of the information content printed or displayed on the medium using a telephone device.

An eighty fourth object is to provide a telephone method comprising or consisting of scanning and/or reading a barcode printed or displayed on a medium containing more than the information content printed or displayed on the medium using a telephone device.

An eighty fifth object is to provide a telephone method comprising or consisting of scanning and/or reading a barcode printed or displayed on a medium containing footnote information relating to the information content printed or displayed on the medium using a telephone device.

An eighty sixth object is to provide a telephone method comprising or consisting of scanning and/or reading a barcode printed or displayed on a medium serving as a hyperlink to one or more websites using a telephone device.

An eighty seventh object is to provide a telephone method comprising or consisting of scanning and/or reading barcode printed on a medium and converting the information content of the barcode into speech or a voice using a telephone device.

An eighty eighth object is to provide a telephone method comprising or consisting of printing a barcode with a telephone device.

An eighty ninth object is to provide a telephone method comprising or consisting of scanning and/or reading a barcode, and displaying the information content of the barcode on a display of a telephone device.

A ninetieth object is to provide a telephone method comprising or consisting of converting speech to a barcode printed or displayed on a medium, scanning and/or reading the barcode printed on the medium, and converting the information content into speech.

A ninety first object is to provide a telephone method comprising or consisting of scanning and/or reading a barcode with a telephone device, and wirelessly transmitting at least a portion of the information content of the scanned barcode to another wireless device.

A ninety second object is to provide a telephone method according to the present invention using a cell phone.

A ninety third object is to provide a communication method of converting barcode into speech.

A ninety fourth object is to provide a communication method comprising or consisting of converting bar code into speech.

A ninety fifth object is to provide a method of converting barcode into speech comprising or consisting of the step of scanning barcode.

A ninety sixth object is to provide barcode speech.

A ninety seventh object is to provide a device configured to provide barcode speech.

A ninety eighth object is to produce speech from a barcode.

A ninety ninth object is to configure a barcode to provide speech.

A one-hundredth object is to provide a barcode configured with text information content.

A one-hundred first object is to configure a barcode to contain information content that can be converted into text.

A one-hundred second object is to provide a barcode with picture information content.

A one-hundred third object is to provide a barcode with digital image information content.

A one-hundred fourth object is to configure a barcode to contain information content that can be converted into a picture.

A one-hundred fifth object is to configure a barcode to contain information content that can be converted into a digital image.

A one-hundred sixth object is to provide a digital barcode configured to be converted into speech.

A one-hundred seventh object is to provide a method of configuring a barcode into speech.

A one-hundred eighth object is to provide a method of converting a barcode into speech by scanning the barcode.

A one-hundred ninth object is to provide a method of converting a barcode into speech by digitally imaging the barcode.

A one-hundred tenth object is to provide a method of converting a barcode into speech.

A one-hundred eleventh object is to provide a method of converting a barcode into speech comprising or consisting of the step of scanning a barcode configured to provide speech.

A one-hundred twelfth object is to provide a method of converting a barcode into speech comprising or consisting of the step of digitally imaging a barcode configured to provide speech.

A one-hundred thirteenth object is to provide a method of converting barcode into speech.

A one-hundred fourteenth object is to provide a method of converting speech into barcode.

A one-hundred fifteenth object is to provide a method of storing text in the format of a barcode.

A one-hundred sixteenth object is to provide a method of storing a picture in the format of a barcode.

A one-hundred seventeenth object is to provide a method of converting speech into a barcode.

A one-hundred eighteenth object is to provide a method of converting speech into a barcode and then converting the barcode into speech.

A one-hundred nineteenth object is to provide a method of converting text to speech using a barcode.

A one-hundred twentieth object is to provide a method of converting speech to text using a barcode.

A one-hundred twenty first object is to provide a communication method of converting barcode into speech.

A one-hundred twenty second object is to provide a communication method comprising converting bar code into speech.

A one-hundred twenty first object is to provide a method of converting barcode into speech comprising the step of scanning barcode.

A one-hundred twenty second object is to provide barcode speech.

A one-hundred twenty third object is to provide a device configured to provide barcode speech.

A one-hundred twenty fourth object is to produce speech from a barcode.

A one-hundred twenty fifth object is to configure a barcode to provide speech.

A one-hundred twenty sixth object is to provide a barcode configured with text information content.

A one-hundred twenty seventh object is to configure a barcode to contain information content that can be converted into text.

A one-hundred twenty eighth object is to provide a barcode with picture information content.

A one-hundred twenty ninth object is to provide a barcode with digital image information content.

A one-hundred thirtieth object is to configure a barcode to contain information content that can be converted into a picture.

A one-hundred thirty first object is to configure a barcode to contain information content that can be converted into a digital image.

A one-hundred thirty second object is to provide a digital barcode configured to be converted into speech.

A one-hundred thirty third object is to provide a method of configuring a barcode into speech.

A one-hundred thirty fourth object is to provide a method of converting a barcode into speech by scanning the barcode.

A one-hundred thirty fifth object is to provide a method of converting a barcode into speech by digitally imaging the barcode.

A one-hundred thirty sixth object is to provide a method of converting a barcode into speech.

A one-hundred thirty seventh object is to provide a method of converting a barcode into speech including the step of scanning a barcode configured to provide speech.

A one-hundred thirty eighth object is to provide a method of converting a barcode into speech including the step of digitally imaging a barcode configured to provide speech.

A one-hundred thirty ninth object is to provide a method of converting speech into barcode.

A one-hundred fortieth object is to provide a method of storing text in the format of a barcode.

A one-hundred forty first object is to provide a method of storing a picture in the format of a barcode.

A one-hundred forty second object is to provide a method of converting speech into a barcode.

A one-hundred forty third object is to provide a method of converting speech into a barcode and then converting the barcode into speech.

A one-hundred forty fourth object is to provide a method of converting text to speech using a barcode.

A one-hundred forty fifth object is to provide a method of converting speech to text using a barcode.

A one-hundred forty sixth object is to provide a printing device configured to print barcode.

A one-hundred forty seventh object is to provide a printing device configured to print text and barcode.

A one-hundred forty eighth object is to provide a printing device configured to simultaneously print text and barcode.

A one-hundred forty ninth object is to provide a laser printing device configured to print text and barcode.

A one-hundred fiftieth object is to provide a barcode machine voice;

A one-hundred fifty-first object is to provide a barcode recorded voice.

A one-hundred fifty-second object is to provide a barcode human voice.

A one-hundred fifty-third object is to provide a barcode human impressionist voice.

A one-hundred fifty-fourth object is to provide a barcode scanning device configured to communicate with a cell phone device.

A one-hundred fifty-fifth object is to provide a barcode scanning device configured to communicate wirelessly with a cell phone device.

A one-hundred fifty-sixth object is to provide a barcode scanning device configured to communicate with a cell phone device, the barcode scanning device configured to contact a medium supporting the barcode when the barcode scanning device is scanning the barcode.

A one-hundred fifty-seventh object is to provide a barcode scanning device configured to communicated with a cell phone device, the barcode scanning device configured to contact the barcode when the barcode scanning device is scanning the barcode.

A one-hundred fifty-eighth object is to provide a method of converting information into a barcode data configuration, and then transmitting the barcode data configuration from a barcode scanning device to another device such as a cell phone.

A one-hundred fifty-ninth object is to provide a method of converting information into a barcode data configuration, and then transmitting the barcode data configuration over the Internet.

A one-hundred sixtieth object is to provide a method of converting information into a barcode data configuration, and then transmitting the barcode data configuration using a cell phone.

A one-hundred sixty first object is to provide a method of converting information into a barcode data configuration, transmitting the barcode data configuration, and converting the barcode data configuration into the information.

The invention is not limited by the above objects. These and other objects will be apparent from the disclosure as set forth herein below.

This application is directed to a barcode, barcode device, barcode system, and barcode method.

The barcode, for example, is configured to be converted into a voice, speech, and/or a language. Specifically, the markings defining the barcode are configured or arranged in a specific pattern that can be scanned and/or read with an electronic device, preferably a portable, hand held, and/or personal electronic device (e.g. telephone, cell phone, smart phone, personal computer, personal computing device, pad, iPad, iPhone) and then converted into speech. The higher the density of the barcode, the more voice, speech, and/or language information can be stored by the barcode. A two-dimensional high density matrix barcode (e.g. Data Matrix barcode) can be used to store a significant amount of barcode data, including a number of characters to provide for a voice, speech, and/or a language and graphic information (e.g. graphic displays, designs, pictures, images, equations, graphs, illustrations, tables, charts, and other visual data forms, types, or formats).

The barcode device, for example, can comprise a barcode printed or displayed on a medium or display (e.g. barcode in combination with medium). The medium can be any material, surface, or object that can be printed with a barcode and/or can display a barcode in a manner to allow the barcode to be scanned and/or read. For example, a barcode device can comprise a barcode and visual information (e.g. text, numbers, designs, pictures, images, equations, graphs, illustrations, tables, charts, and other visual data forms, types or formats) printed or displayed on a medium or display. As a further example, a barcode device can comprise a barcode and visual information printed or displayed on a medium or display, the barcode containing at least a portion of the visual information (i.e. redundant information content in different forms or formats on a medium). As an even further example, a barcode can comprise a barcode and visual information or data printed or displayed on a medium or display, the barcode containing at least a portion of the visual information or data, and the barcode configured to be scanned and/or read with an electronic device to convert the barcode into a voice, speech, and/or language.

The barcode can be a Braille type. The term “Braille type” means Braille, the same as Braille, similar or equivalent to Braille, related to Braille, same or similar function or operation as Braille, or otherwise a device system, method, process or means for converting information from one form to another form that can be used or sensed (e.g. voice, speech, or heard and/or felt) by the blind, low vision, handicapped, disabled, and illiterate. The term “Braille type” is not limited to actual Braille.

The term “printed matter” refers to print, text, images, or visual data printed or supported on a medium. The term “printed matter” can refer to any of a wide variety of printed matter comprising books, hard cover books, bound books, paperback books, documents, bills, receipts, publications, newspapers, magazines, comic books, toys, games, electronic games, journals, periodicals, reading materials, literature, brochures, memos, notes, certificates, commercial paper, money, paper money, negotiable instruments, stock certificates, legal documents, legal papers, motions, discovery, interrogatories, decrees, judgments, wills, trusts, stamps, business cards, folders, files, packaging, boxes, letters, envelopes, labels, notebooks, papers checks, negotiable instruments, checks, money orders, credit cards, signs, building signs, highway signs, construction signs, and any and all other types of conventional or new types of printed matter. Further, the term printed matter can specifically refer to marks, fonts, indicia, text, images, pictures, illustrations, texture, dots, bumps, barcodes, matrix, and even Braille itself provided on a medium.

The printed matter is printed, supported, and/or displayed on a medium comprising paper, material, surface, object, newspaper, cardboard, film, plastic, wood, metal, glass, ceramic, composite material, cloth, fabric, and any and all other types of conventional or new types of surfaces, mediums and/or substrates. Alternatively, or in addition, the print matter can be displayed matter, for example, as text, pictures, images, diagrams, graphs, equations, illustrations, tables, figures visually displayed or invisibly displayed on a television screen, monitor, electronic display, cathode ray tube (CRT), plasma screen, liquid crystal display, or otherwise displayed instead of being printed. This displayed matter can be permanent, or can be changed or varied with time or otherwise dynamic.

The barcode can be configured to be supported and displayed visually by a medium, preferably the medium also supporting the printed or displayed information, information content, and/or visual matter. The barcode can be a machine-readable barcode. For example, the barcode can be printed or displayed matter, and configured to be read with a scanner, in particular a portable, hand held, and/or personal scanner, preferably a personal electronic device, more preferably a cell phone, most preferably a smart phone. More specifically, the barcode can be printed or displayed on a medium, and then read by a scanner.

The barcode can be in the format of a one (1) dimensional bar code, two, (2) dimensional bar code, three (3) dimensional bar code, multiple dimensional barcode, high density barcode, matrix code, two-dimensional matrix barcode (e.g. Data Matrix). The information content of the barcode can be converted to printed matter and/or displayed matter that can be read and understood by a person in the context of alpha numeric characters, text, words, sentences, paragraphs, chapters, images, pictures, graphs, equations, diagrams, tables, illustrations, charts, maps, and the printed and/or displayed matter can be converted into barcode.

The barcode can be a one (1) dimensional bar code that can be machine read and converted into an audio voice or speech designating a particular letter and/or word. A Braille type, for example, a two (2) dimensional matrix bar code or matrix code can provide enough information content to allow such barcodes to be read and converted into an audio voice or speech pronouncing entire words and sentences and even a language in a particular dialect.

The barcode can be provided in a variety of configurations or formats. For example, the barcode can be provided on one or more separate pages (e.g. at or near the beginning or end of a book). Alternatively, the barcode code can be printed in the top, side and/or bottom margins of a printed page (e.g. page printed in all text or mostly text and illustrations). Preferably, at least a portion of the printed information or matter visually displayed on a particular page is contained within the barcode printed or displayed on the same page. For example, the barcode can be provide in a side margin along the binding of the particular book, and can be read from top to bottom, bottom to top, or in any order as the handset will determine proper order, by a portable, hand held and/or personal barcode scanner, for example, a personal electronic device, in particular a telecommunications device such as a cell phone or smart phone. Alternatively, the barcode can be interlineated between the lines of the printed text or information displayed on a particular page. Alternatively, the barcode can be overprinted over the printed matter using an invisible ink (e.g. infrared type ink). For example, the barcode scanner can use an infrared or ultraviolet detector, for example, to read the overprinted Braille type code.

The barcode system can comprise or consist of the barcode or barcode device, and the barcode scanning and/or reading device. For example, the barcode system can comprise or consist of a printed document comprising or consisting of both printed or displayed matter and one or more printed barcodes thereon.

The one or more barcodes can contain the same, less, more and/or different information content verse the printed information or matter printed or displayed thereon. The barcode can have the same information content as a word, sentence, paragraph, page, and/or article. The barcode system can also comprise or consist of the portable, hand held, and/or personal electronic device configured for scanning the one or more barcodes. The portable, hand held, and/or personal barcode scanning and/or reading device is configured to scan and read the printed or displayed barcode, and convert same into a voice, speech, and/or language. The barcode can also be encrypted to provide added operational features or security features.

The portable, contact, near contact, and non-contact hand held, and/or personal barcode device can be configured (i.e. provided with hardware and/or software) to allow the portable, hand held, and/or personal barcode device to read the printed or displayed barcode, and then interpret or convert the scanned and read barcode into a voice, speech and/or language, for example, outputted from a audio speaker or speaker system of the barcode device and/or communicate with another electronic device to output the voice, speech and/or language (e.g. the audio signal is communicated via wire or wirelessly to another electronic device, e.g. blue toothed). The portable aspect of a hand held type or lap top type barcode scanner greatly facilitates mobility of the system for the blind, low-vision, handicapped, disabled, and/or illiterate person needing to move the system from one location to another, particularly to, from or within a home, school, and/or job environment.

The barcode device can comprise information content in one format that can be converted to information content in another format. For example, the barcode is configured or coded with information in one format (e.g. marks, blocks, cells) that can be converted into information content in another format (e.g. voice, speech, language). The barcode device can comprise the barcode and information or information content printed or displayed on a medium. The information content configured with the barcode can contain at least the information content visually displayed on the medium so that when the barcode is scanned and read with an electronic device, the electronic device emits an audio signal as a voice, speech, and/or language matching the wording displayed as text and/or or matching the illustration, image and/or picture being described.

Again, the information content or equivalent of the barcode can be less, same, more and/or different from the information content visually displayed on the medium on which the barcode is printed, supported, or displayed.

A barcode device can comprise or consist of a portable, hand held, and/or personal electronic device, in particular a telecommunication, cell, or other telephone device. A telephone device can be a cell phone, for example, a smart phone, PDA, Blackberry cell phone, iPhone, iPad, and all other types of phones and mobile communication devices, based on a variety of Operating Systems (OS), for example, Android OS, Symbian OS, Windows OS etc.

The information content contained in the barcode printed on a particular page or document can contain at least a portion of the information content displayed by the printed matter provided on the particular page. Alternatively, the information content contained in the barcode printed or displayed on a particular page or document can contain the same information content contained in the printed matter displayed on the particular page. Alternatively, the information content contained in the barcode printed on a particular page or document contains more information content contained in the printed matter on the particular page. Alternatively, the information content contained in the barcode printed on a particular page or document contains at least a portion of the information content contained in the printed matter on the particular page plus additional information content not contained in the printed matter. Alternatively, the information content contained in the barcode printed on a particular page or document contains information content different from the information content contained in the printed matter.

The barcode system can comprise or consist of a barcode device, for example, a telephone device in combination with printed matter comprising or consisting of a barcode. For example, a barcode having information content relating to the printed matter. As a further example, the information content of the barcode relates to the information content of the particular page or document. As an even further example, the information content of the barcode is the same or similar, or otherwise is representative of the information content of the printed matter.

The barcode system can comprise or consist of a printed document having both printed matter and printed barcode acting as a copy or file (e.g. digital copy or file) of the information content of the printed matter, in combination with a barcode scanner, for example, a telephone device. For example, a cell phone device. The barcode scanner and/or reader can be configured to scan and read the printed barcode, and convert same into a machine voice or speech. The printed barcode can also be encrypted to provide added operational features and/or security aspects.

The barcode device can comprise or consist of a scanner configured with hardware and software configured to allow the hand held scanner to read the printed barcode, and then convert the read barcode into a machine voice or speech outputted from a audio speaker or speaker system of the barcode device (e.g. hand held barcode telephone, cell phone, smart phone, pad, iPad, reader, laptop computer, personal electronic device, personal computer). The portable aspect of a hand held type scanner greatly facilitates mobility of the system for the blind, low vision, handicapped, disabled, and/or illiterate to allow a person to move the device or system from one location to another, particularly within a job environment.

The barcode scanner can be incorporated into an electronic device (e.g. barcode device, telephone, cell phone, smart phone, pad, notebook, personal computer, personal electronic device), or can be a separate component that can be connected by a wire and/or wireless connection (i.e. communication link). For example, a wireless bar code scanner is provided with a wireless communications link (e.g. blue tooth) to the electronic device.

This application covers a barcode, barcode device, barcode system, barcode method, barcode speech, barcode speech device, and barcode cell phone.

The barcode can be used as speech, or to generate speech. A barcode can be configured to produce speech. The barcode is configured to store information content that can be converted into speech. Inversely, speech can be converted into the barcode.

The barcode can be configured to store speech in all languages, and can be used as a universal translator. Alternatively, speech of different languages can be store is a single barcode, or in separate barcodes (e.g. one language per barcode or multiple languages per barcode). The barcode can be speech, the same as speech, or a speech equivalent.

The barcode can be a one (1) dimensional barcode, two (2) dimensional barcode, three (3) dimensional barcode, higher dimensional barcode, high density bar code, two-dimensional bar code, matrix code, matrix bar code, two-dimensional matrix barcode (e.g. Data Matrix barcode), holographic barcode, encrypted barcode, proprietary barcode, custom barcode, digital barcode, low density bar code, and high density barcode. For example, the bar code can be a high density barcode having a large amount of digit content (e.g. preferably at least 1,000 characters, more preferably 1,500 characters, most preferably 2,000 plus characters).

The barcode can contain information content. The information content, for example, can be code, computer code, digital code, text, letters, numbers, characters, words, sentences, phrases, paragraphs, music, sections, chapters, graphs, mathematical equations, diagrams, illustrations, advertisements, signage, menus, pictorial, image, digital images, links, computer links, internet links, web links, video, digital video, video streams, and other types of currently available or developed data or information content.

The barcode can be printed, imaged, displayed, or other ways of visually generating a barcode image. For example, the barcode can be printed by a printing press, intaglio press, offset press, ribbon printer, film printer, transfer ink printer, ink jet printer, laser printer, or other suitable printing device or apparatus.

The information content contained in the barcode can be converted into a particular barcode arrangement depending on the particular type of barcode (i.e. the barcode is coded with the particular information content). For example, the information content is in a digital format, and is then converted into a digital bar code.

The bar code, for example, is printed onto a medium. The medium, for example, can be paper, news print, magazine print, print board, cardboard, film, plastic film, plastic material, metal film, metal material, ceramic, wood, composite, material surface, or any other medium capable of supporting print, including electronic visual displays or graphics.

The barcode, for example, can be printed on a page, document, newspaper, magazine, book, brochure, instructions, money, paper money, checks, banking documents, receipts, signs, street signs, building signs, bill boards, any substrate capable of hosting or supporting distinguishable patterns, including liquid or gaseous elements.

The barcode can be scanned and read into an electronic device. For example, a CCD and/or laser scanner is used to scan the barcode. The electronic device can be a barcode electronic device configured to convert the electronic signal of the scanned barcode into speech. The electronic device comprises or consists of hardware and software for converting, for example, directly converting the scanned barcode signal into speech.

The electronic barcode device can be a contact or close contact, hand-held and portable electronic device such as a telephone, cell phone, smart phone, specialized cell phone, specialized electronic device, pad, personal computer, personal electronic device, or other suitable electronic device for personal use, in particular portable electronic devices configured to be carried by persons or individuals on a daily basis. However, a non-contact embodiment (e.g. digital camera) can be suitable. The current state-of-the-art smart cell phones are particularly suitable of being configured to convert barcode into speech. These can be the cell phones, smart phones, PDA, Blackberry cell phones, iPhones, and all phones and mobile communication devices, based on a variety of Operating Systems (OS), for example, Android OS, Symbian OS, Windows OS etc.

The hardware necessary typically exists within the cell phones already in the form of cameras of varying quality, within the handsets, themselves. The higher the quality of the optics and pixel sensitivity and resolution, the greater the density of code that can be discerned by the camera. In conjunction with the optics and resolution of the camera, code character density is also a function of the software providing interpretation of the signals provided by the camera captured data from the bar codes themselves. Various cell phone cameras have the desired capabilities, however, a megapixel capacity from 2-24 megapixels and above is desired, thus providing ultimate resolution consistent with printers and substrates capable of >20,000 dpi print resolution. Typical of low density code applications, are: UP Code, and i-nigma.

The contact scanning of barcode can provide advantages of enhancing the image capturing capabilities to the barcode scanning device. The “contact” provides a tactile signal, image stability, standardized micro-barcode capability, standardized focal distance, and fixation of the barcode scanning device to successfully capture the barcode image.

For illiterate individuals and individuals with disabilities, the current lens format of the smart cell phone is suitable for scanning a barcode. Specifically, in operation the cell phone is held above the surface of the page or document over the position of the barcode to allow auto-focusing of the cell phone camera on the barcode and capture of a digital image of the barcode.

For blind and low vision individuals, a specialized smart phone or an optical module add-on is preferable. Specifically, in operation the cell phone is preferably placed in contact with the surface of the page or document and moved around until the cell phone is registered with the bar code. The cell phone can provide a signal (e.g. noise) when the cell phone is properly registered with the barcode and the user can push the button to take the digital image. Alternatively, the cell phone can be configured to automatically trigger taking the digital image when moving the cell phone over the bar code and then providing a signal (e.g. noise).

The add-on optical module can be fitted onto the casing of the cell phone, or alternatively, be a replaceable panel of the casing of the cell phone. The add-on optical module can comprise added illumination and one or more additional lens and one or more mirrors to significantly reduce the focal length of the single conventional lens found on many cell phones today. Alternatively, a new cell phone platform can be developed to provide a specialized cell phone with a lens and added illumination system to allow contact of the cell phone with the surface of the page or document having a barcode.

The barcode can be configured to contain information content (e.g. text information content) and configured to function as an Internet link. Alternatively, a page or document is provided with at least one barcode providing information content and at least one barcode providing an internet link to a user.

The electronic device according to the present invention can be provided with a global positioning system (GPS) that is activated upon scanning a barcode to inform the user of his or her location, and other information regarding the particular location of the user.

The barcode can be provided on a page printed with text so that when a user scans the barcode the text on the page is read to the user as a voice or speech. The same bar code, or additional barcodes, can be printed on the same page to add footnote information and/or advertisement having a fixed information content. The same bar code, or additional bar codes according to the present invention, can be printed on the same page to function as internet links to provide real time information content (e.g. updated footnote information, portions of books, updated annotations, updated advertisement, news, weather, time, date, location, temperature.

As an optional feature, an RFID sensing system may be included within the handset to provide alerts of automobile RFID tagged vehicles in traffic environments. Further, the scan window of the hand-held and/or portable scanner (e.g. cell phone) can be slotted in such a manner that single sheet documents and currency may be inserted into the slot, exposing the bar code for quick and convenient scanning.

The barcode device can, for example, produce an audio voice or speech and/or a display. The voice or speech can sound like a machine, human, cartoon, synthesized, animal-like, impressionist, famous person, or other desirable voice or speech. For example, a digitally synthesized voice of Abraham Lincoln reads the Gettysburg Address, John Wayne reads a Western novel, Thomas Jefferson reads the Declaration of Independence, Michael Jackson reads his musical lyrics to some of his famous songs. The display can be a graphic representation of this information or data.

This application is in addition directed to converting information contained in a barcode into an electronic bar code signal. In addition, this application is directed to converting the electronic bar code signal into speech, voice, display, or other data format that can be perceived or usable by a user.

This application is directed to transmitting and/or receiving an electronic bar code signal. For example, the electronic bar code signal is communicated over a wire or wirelessly from one electronic device or system to another electronic device or system, and/or can be stored or retrieved from a memory (e.g. electronic memory). The electronic bar code signal can be configured as a compressed data format for information or data. The physical nature and structure of a barcode is conducive to electronically transmitting/receiving and/or storing/retrieving information or data compressed or compacted into a barcode. The information content of the information or data in the barcode format is electronically smaller in size and requires less space.

For example, information or data is converted into an electronic bar code signal, and then transmitted/received and/or stored/retrieved, and then converted back to the original or a different information or data format (e.g. the same original data format or other useable data format).

The barcode provides for data compression, for example, of data in font format. The conversion of font data to barcode data and then into the electronic barcode signal allows for data manipulation. For example, the data can be transmitted/received in data “bursts” (e.g. millisecond signal bursts) to transmit a high density electronic data signal. The electronic signal can be encoded or encrypted to avoid detection and capturing (e.g. copying). For example, an electronic message can be transmitted/received in tiny data snippets or packets. These data snippets or packets (e.g. compressed data files), for example, can be placed in a queue to be sent when the rate of transmission is lower or lowest (e.g. late at night on telephone lines). Thus, more information or data can be sent on the same transmission line or cable, or wirelessly.

The Braille barcode format or type can be referred to at Print Disabled Text™ or PDT™. Again, the barcode can be customized for a particular application based on a variety of different needs or requirements.

The barcode device, for example, can be configured to go from speech to text; text to PDT file; PDT transmitted via the cell phone; PDT received by another cell phone; received PDT file opened; and text to speech. Thus, speech into a cell phone can be converted into PDT files that can be transmitted, high speed over the communication line or wirelessly. The received PDT file can be instantly converted into text and speech. The purpose of this configuration is to provide an instant conversation captioning cell phone capable of visual and audio real time teleconversion for the hearing disabled world.

The barcode can be printed on a page or document configured to identify the orientation of the page or document to a blind or low vision user. For example, a barcode is printed in proximity to a small corner portion removed (i.e. dog ear).

### BRIEF DESCRIPTION OF THE DRAWINGS

FIG. 1 is a perspective view of a barcode device according to the present invention, namely a book having printed texted (i.e. printed matter) in combination with barcode according to the present invention, and the barcode system according to the present invention including the barcode device according to the present invention in combination with printed barcode on a medium.

FIG. 2 is a top planar view of the barcode device according to the present invention.

FIG. 3 is a bottom planar view of the barcode device, as shown in FIG. 2.

FIG. 4 is an elevational end view of the barcode device, as shown in FIGS. 2 and 3.

FIG. 5 is a perspective view of another embodiment of the barcode device and barcode system.

FIG. 6 is a top planar view of a page showing printed matter in combination with printed Braille type bar code according to the present invention.

FIG. 7 is a top planar view of another page showing printed matter in combination with printed bar code.

FIG. 8 is a perspective view of another embodiment of the barcode device according to the present invention configured to display matter and Braille type bar code according to the present invention.

FIG. 9 is a perspective view showing a cane for the handicapped provided with a barcode device according to the present invention configured to scan a sign provided with Braille type bar code according to the present invention.

FIG. 10 is a sample of a two-dimension matrix bar code according to the present invention.

FIG. 11 is a front perspective view of a cell phone according to the present invention.

FIG. 12 is a back planar view of the cell phone shown in FIG. 11.

FIG. 13 is side elevational view of the cell phone shown in FIGS. 11 and 12.

FIG. 14 is a front planar view of another cell phone according to the present invention.

FIG. 15 is a back diagrammatic view of the cell phone shown in FIG. 14 showing the lens arrangement.

FIG. 16 is a side diagrammatic view of the lens arrangement shown in FIG. 15.

FIG. 17 is a front planar view of a barcode mouse according to the present invention.

FIG. 18 is a side elevational view of the barcode mouse shown in FIG. 17.

FIG. 19 is an end elevational view of the barcode mouse shown in FIGS. 17 and 18.n

FIG. 20 is an opposite end elevational view of the barcode mouse shown in FIGS. 17 and 18.

FIG. 21 is a side diagrammatic view showing a non-contact barcode scanning arrangement with a cell phone according to the present invention.

FIG. 22 is a side diagrammatic view showing a non-contact barcode scanning arrangement with a cell phone according to the present invention.

FIG. 23 is an example of the barcode system according to the present invention showing the text of the preamble to The Constitution and corresponding barcodes with the same information content to be read with a cell phone according to the present invention.

FIG. 24 is an example of the barcode system according to the present invention showing a portion of the text of The Bill of Rights and corresponding barcodes with the same information content to be read with a cell phone according to the present invention.

FIG. 25 is an example of the barcode system according to the present invention showing the text of a sample menu and the corresponding barcodes with the same information content to be read with a cell phone according to the present invention.

FIG. 26 is an example of the barcode system according to the present invention showing the text of a sample recipe and corresponding barcodes with the same information content to be read with a cell phone according to the present invention.

FIG. 27 is flow diagram of an example the barcode cell phone system according to the present invention.

FIG. 28 is a continued flow diagram shown in FIG. 27.

FIG. 29 is a flow diagram of another example of the barcode cell phone system according to the present invention.

FIG. 30 is the continued flow diagram shown in FIG. 29.

FIG. 31 is a side elevational view of a barcode scanner.

FIG. 32 is a perspective broken away view of the barcode scanner shown in FIG. 31.

FIG. 33 is a perspective view of an example of a barcode scanner connected wirelessly with a cell phone for scanning and reading and/or displaying information content of a two-dimensional matrix barcode.

### DETAILED DESCRIPTION

The barcode is configured to contain or store information content, for example, a substantially large information content. The barcode can be configured or arranged to allow the information contained or stored within the barcode in one format (e.g. marks, bars, blocks, cells) to be converted into one or more other formats (e.g. voice, speech, language, text, picture, image, sounds, songs, video).

The barcode can be printed, applied, or displayed on a material, surface, object, display, electronic display, screen and/or electronic screen in a manner so that it can be scanned, read, and converted into a one or more other informational formats. The barcode once printed, applied, or displayed on a material, surface, object, display, electronic display, screen and/or electronic screen becomes a barcode device.

For example, the barcode and visual information content can be printed or displayed on a medium or display. The printed matter or visual information is supported by a medium, and the barcode can be provided on the same medium

The printed matter can be any of a wide variety of printed matter including documents, pages, books, hard cover books, paperback books, publications, newspapers, magazines, journals, periodicals, reading materials, literature, brochures, memos, notes, certificates, commercial paper, money, paper money, negotiable instruments, stock certificates, bills, notices, legal documents, legal papers, motions, discovery, interrogatories, decrees, judgments, wills, trusts, stamps, business cards, folders, files, packaging, boxes, letters, envelopes, labels, notebooks, papers checks, negotiable instruments, checks, money orders, credit cards, and any and all other types of conventional or new types of printed matter.

The printed matter is supported on a medium, for example, paper, bond, newspaper, cardboard, plastic, plastic sheet, film, plastic film, metal, metal sheet, glass, ceramic, composite material, cloth, fabric, and any and all other types of conventional or new types of mediums.

The barcode according can be a one (1) dimensional barcode, high density barcode, two (2) dimensional bar code, matrix code, two-dimensional matrix barcode (e.g. Data Matrix, QR code), three (3) dimensional bar code, holographic bar codes, stylized-filigree or scroll type bar codes and simple discrete symbologies to represent lowest character content, particularly for currency denomination, or other suitable barcode formats. The barcode code is configured to be machine read, for example, by a barcode scanning device, in particular a portable, hand held, and/or personal scanner, preferably a personal electronic device, telephone device. For example, the cell phone can be a smart phone. The portable, hand held, and/or personal scanner can be a stand-alone electronic device.

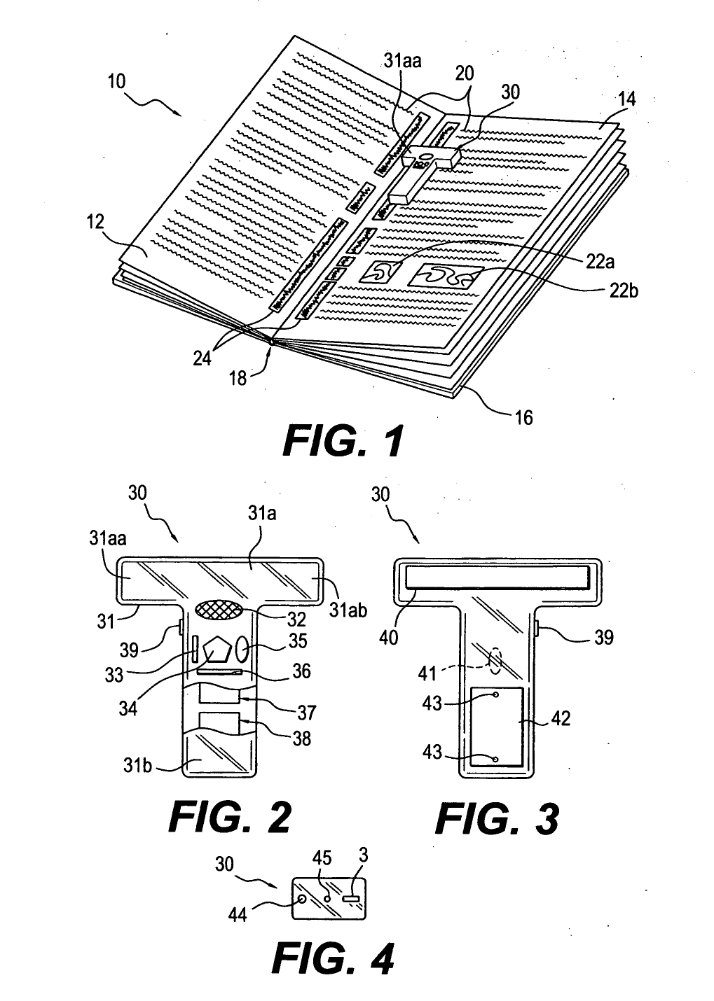

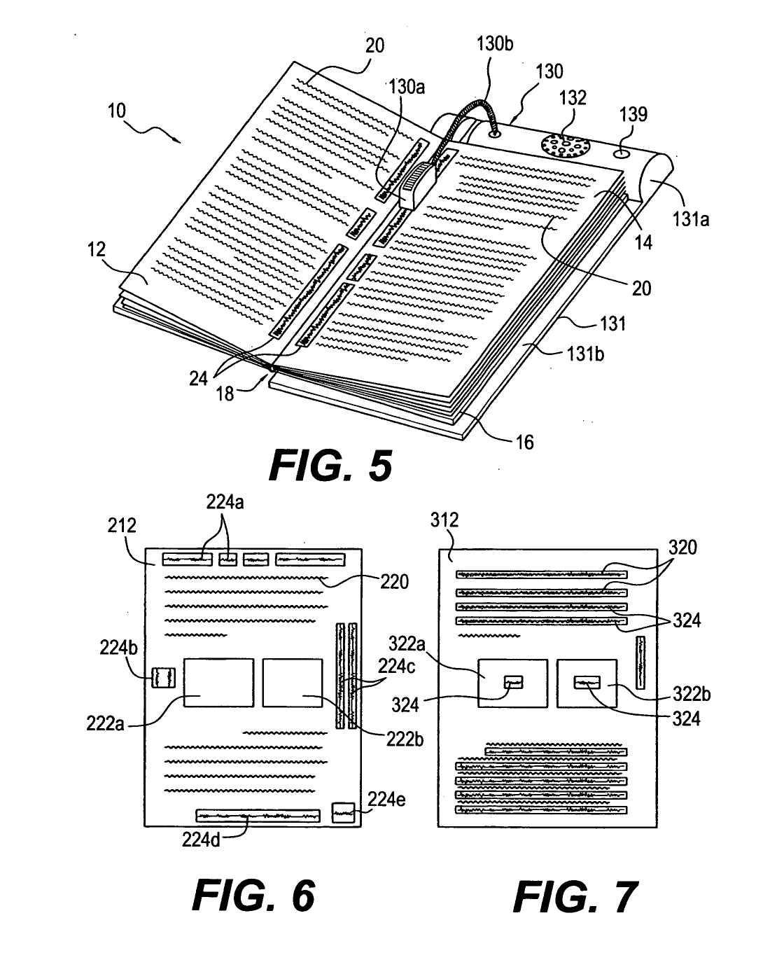

A book 10 is shown in FIG. 1. The book 10 is provided with one or more pages 12, 14 bound at the inner edges 12a, 14a, respectively, to book cover 16 to define a gutter, book spine, or binding 18. The pages 12, 14 of the book 10 are printed with text 20, pictures or diagrams 22a and 22b, and barcode 24.

A portable, hand held, and/or personal portable barcode device 30 is shown in FIG. 1 positioned readied to read the barcode 24 from top to bottom on each page. As shown in FIG. 1, the barcode scanning device 30 is configured to contact the page, and glide or slide along and scan the upper surface of pages 12, 14. As shown in FIG. 2, the barcode device 30 is provided with a body 31, including a wider upper body scanning portion 31a and a thinner lower body griping portion 31b. The upper body scanning portion 31a is provided with a left guiding edge 31aa and right guiding edge 31ab. The guiding edges 31aa and 31ab ride along the spine or binding 18 (i.e. gutter) of the book 10, as shown in FIG. 1, allowing page 12 to cooperate and act as a guide with the left guiding edge 31 as of the barcode scanning device 30 as the barcode device 30 is moved from the top of the page 14 to the bottom of the page 14. Page 12 itself acts as a guide due to the angle provided by pages 12 and 14 (i.e. pages 12, 14 are substantially perpendicular to each other when the book 10 is opened). The guiding edge 3lab of the barcode scanning device 30 is used when reading page 12 of book device 10.

The barcode device 30 is provided with an audio speaker 32, volume wheel 33, pause/plan button 34, skip button 35 and rocker button 36. It is important to understand that the barcode device 30, as shown in FIGS. 2 thru 4, is an example of a scanning device. However, other shapes, configurations of the device, button size, button shape, button layouts, type of buttons, switches and speakers can be varied or changed within the context of the barcode device 30. Further, the bar code device 30 is provided with an on-board computer/processor 37 and a rechargeable battery 38. To turn the barcode device 30 on or off, an on/off slide 39 is provided on the side of the lower body gripping portion 31b.

As shown in FIG. 3, the bottom side of the barcode device 30 is provided with an omni-directional photo emitter/receptor 40, a scanner light trigger 41, a battery/processor access panel 42, and a pair of securing screws 43 for removably retaining the access panel 42 onto the bottom of the body 31 of the barcode device 30.

As shown in FIG. 4, the lower end of the lower body gripping portion 31b is provided with a head phone jack 44, a power supply/battery recharging jack 45 and a mini U.S.B. cord 46.

The barcode device 30 can have several different configurations. For example, the barcode device 30 is portable, hand-held and/or personal electronic device. Alternatively, a desktop scanner configured to read full pages (e.g. computer scanner) can be used for scanning a page or document.

The barcode device 30 includes a scanner head, interpretive electronic processing and memory software and/or hardware, and audio and/or visual display. The configuration of the housing itself is less of importance than component synergism and common function. A considered exception provides for a scanning head configuration on the portable, hand-held scanner to accommodate the apex of the page interface in a book, magazine, etc., whereby the apex functions as a physical registration presence to position the scanner in such a way as to be directly confronted with the barcode images at the face of the scanner. Thus, when the scanner head is placed in the apex of the book, with the scanner face “looking” at the right margin of the left page where the barcode is presented, the barcode scanner is registered and ready to be manually scan down the page, all the time reading the barcode text that occurs, with the corresponding printed words of that page. Similarly, when the next (right) page is to be scanned, the scanner is positioned with the scanner head facing the left hand margin of the right page where it can again be manually swept down scanning the column of the bar code corresponding to the printed words of that page. The barcode device 30 is capable of scanning, reading and converting the scanned bar code to various outputs. Alternatively, the barcode is configured to take a digital image of the barcode.

The barcode can be a high density bar code, preferably a two-dimensional matrix barcode. The barcodes can have a variety of fonts, marks, densities, formats each tailored specifically for the application for which it is to be designed. For example, the barcode can be a barcode utilized which has information storage capacity or information content capable of encoding languages. For example, the language selected is one of the main languages, including English, French, Spanish, Japanese, German, Hindi, Arabic, Farsi, Dutch, Pashto, Russian, Chinese. However, other examples can provide for one or more language(s) and multiple dialects.

The barcode can be printed in various configurations, and at one or more locations on a page, document, or book. For example, a book can be printed with barcode on the front cover, back of the front cover, back cover (either or both sides), one or more separate pages, on pages having other printed matter, or any other suitable and accessible location on the page, document, or book. The barcodes can be printed in strips, adhesive or otherwise.

The barcode can be configured or arranged so as to register with a particular page, paragraph, sentence, word, picture, diagram, or other discrete element of printed matter printed on the pages of the book or document. As shown in FIG. 6, printed bar code 224a for the entire text or portion thereof can be provided in the upper margin of the page 212. Alternatively, or in addition printed barcode 224b can be provided in the left margin (e.g. to describe in detail adjacent pictures or diagrams), printed barcode 224c can be provided in the right margin (e.g. two columns, one column for text and one column for sound (e.g. music), or one column for one language and one column for another language), printed type barcode 224d can be provided in the bottom margin (e.g. story book version with text voice or speech combined with sound (e.g. music and background sounds and noises), and printed bar code 224e can be provide in the lower right corner of the page 212 (e.g. to provide text, description of pictures or diagrams, music, sounds, noises for the entire page at one location). In these embodiments, the barcodes are printed at locations on the page 212 not occupied by printed matter (e.g. text 220, pictures or diagrams 222a, 222b).

As shown in FIG. 7, the page 312 is provided with printed matter (e.g. text 320, pictures or diagrams 322a, 322b) and barcode 324 overprinted over the printed matter. The barcode 324 can register exactly on a letter, word, paragraph, picture, or diagram basis, or can be located somewhat off registration with same.

Another example of the barcode device 410 is shown in FIG. 8.

The barcode device 410, for example, is a television screen, computer monitor, electronic screen or display. The barcode device 410 is configured to display printed matter 420 and display bar code 424. A barcode device 430 is configured to scan and read the barcode 424, and convert same into an audio machine voice, speech, or display, the same or similar to the barcode device 30 as shown in FIGS. 1-4. In this particular example, the matter displayed 420 can be permanent or can be changed (i.e. variable) with time as selected by the user. The barcode device 430 can be configured to glide along an edge 411a of the frame 411 of the barcode device 410.

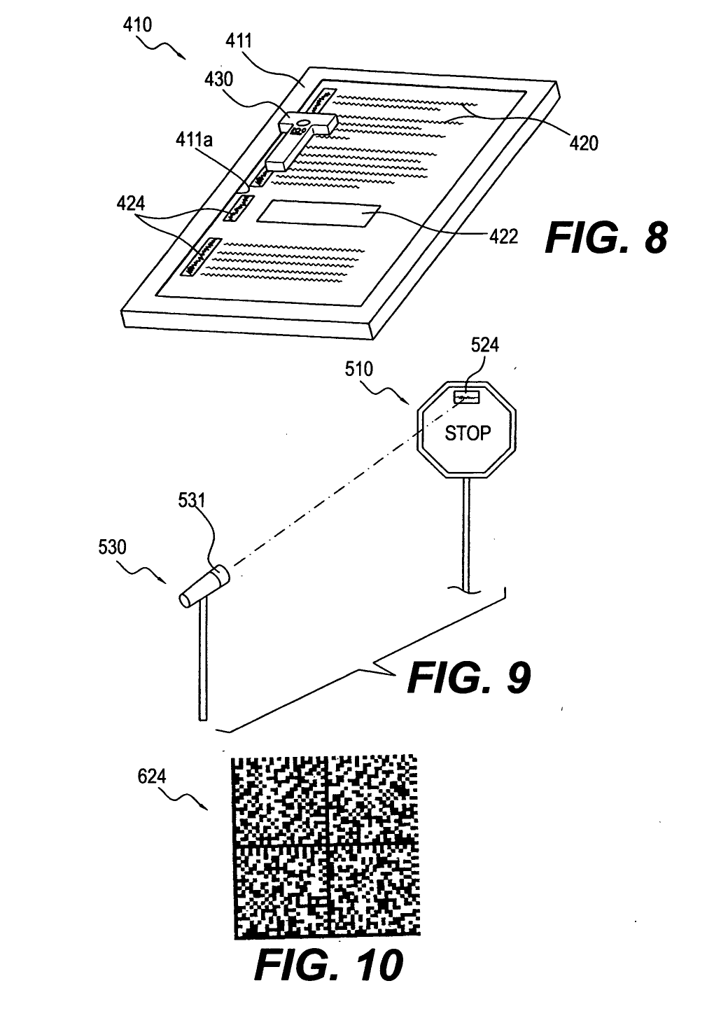

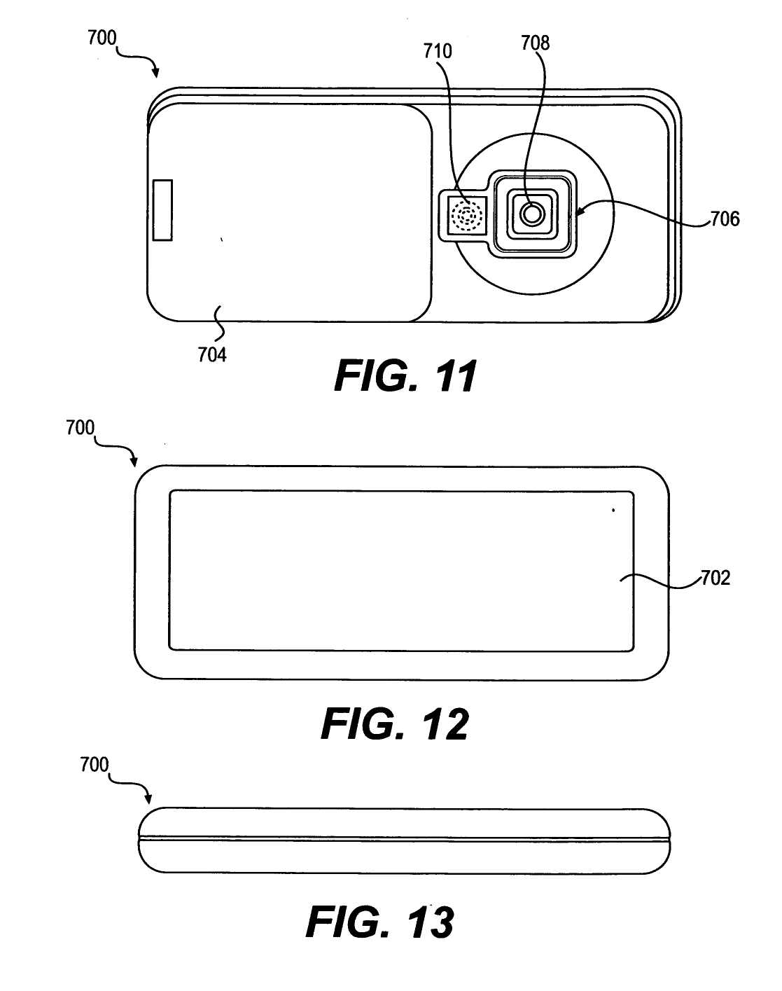

A further example of the barcode device 510 is shown in FIG. 9.

The barcode device 510 is shown as a “stop” sign having a visible or invisible barcode 524 provided (e.g. printed, label, etched) thereon. A barcode device 530 is configured as a handicapped cane, or cell phone, having a scanning head portion 531. The barcode device 530 is configured to scan the bar code located on streets, sidewalks, buildings, doorways, and hallways inside or outside. The barcode device 530 can scan up to distances as great as one hundred feet or more. For example, the barcode can be visibly or invisibly printed or displayed on a wide variety of items encountered during a typical day, including, street signs, signage, building addresses, directories, door signs, bathrooms, warning signals, and a wide variety of other conventional types of printed matters or displays.

An example of a two dimensional matrix barcode 624 is shown in FIG. 10.

This particular barcode 624 is a two (2) dimensional matrix bar code having cells in two dimensions. In this manner, information can be stored into two (2) dimensions, providing a higher information content verses a single dimension barcode.

A barcode can be selected to represent a number of characters in a one (1) dimensional or linear barcode (1-d), PDF 417, two (2) dimensional (2-d) bar code, or any of a variety of some 1-d, and most 2-d, 3-d matrix codes, matrix barcodes, and two-dimensional matrix barcodes (e.g. DataMatrix).

A variation of PDF 417, or a two dimensional matrix barcode can be selected to create the Bar-aille™ barcode. Other versions of other 1-d, 2-d, 3-d, matrix codes, matrix barcodes, two-dimensional matrix barcodes can be developed to provide the same or same type of functions and performance. For example, a one (1) inch by one (1) inch 2-d barcode is capable of containing all the text of the U.S. Constitution, and is capable of being read by a scanner programmed appropriately. This information can be converted into transition data or speech. The transition from text to Bar-aille™ barcode is accomplished through a computer program or software, which can also convert digital data supplied from direct input via keyboard or other means of stored digital data (computers, programs, disks, CDs, etc., directly into Bar-aille™ barcode). The purpose of converting text into Bar-aille™ code, then into speech, or vice-versa, is to enable accessibility of all typed, printed, displayed, or spoken materials via a micro-symbology electronically access device, which would not be sight sensitive or requiring literacy.

The printed barcode can provide for a new micro-symbolic language and a device for use by the low vision, blind, handicapped, disabled, and/or illiterate. For example, an expanded variation of bar code or 2-d bar code, or even a more versatile, matrix code, matrix barcode, two-dimensional matrix barcode (e.g. DataMatrix) or even the greater capacity 3-d or “bumpy” code, which has far greater capacity to encode all the nuances of sophisticated modern languages as is commonly written or spoken can be used. As described, this technology can benefit not only the low-vision and blind, but also can be used to teach the handicapped, cognitive disabled, illiterate, and others being language or dialect illiterate.

This application is also directed to a new language written in a specialized bar code format that addresses all the needs and functions of any contemporary language. To satisfy this need, a new bar code will eventually be assigned to all spoken sound variations of words, through various pluralities, conjugations, tenses, etc. of English. Those familiar with the art would recognize immediately the ability to assign this to another language or languages. However, for example, English can be the chosen language. In all cases the written English word will appear in discrete barcode format unique to that word. This would allow printed matter such as a book, publication, document, magazine, catalog, instruction manual, directions, application, government form, etc., to be encoded in the new bar code “language” which would allow for exact word-to-word, sentence-to-sentence, paragraph-to-paragraph, page-to-page, translation into a barcode document that could be “read” with an appropriate barcode scanner. If one desired the bar code to appear on the same pages of a book as the written conventional print matter, then the bar code could be printed in an area nearby to the area containing the conventional printed matter, or the bar code can be printed directly over the conventional printed matter. In order to reduce misreading of either the visible printed English text or the visible bar code, the bar code or new language can be printed invisibly. The bar code need not be visible as it is designed to facilitate reading for non-sighted persons, and thus the user would be unable to see the barcode anyway. Thus, a book could be written in conventional print for sighted persons while also printed invisible (e.g. ultraviolet or infrared responsive inks which are not visible to the sighted human eye). Since the new language or bar code is invisible, the invisible bar code may be overprinted directly over the English print matter for the sighted.

It should not be construed that the present invention is restricted to visible or invisible Braille type bar coding or restricted to only the English language. Since English has more words than many other languages, it would be much easier to translate the new barcode or language according to the present invention into French, German, Spanish, and essentially all the other languages, and thus English has been chosen as an example, but is not restricted to that language.

Further, a book is not the only delivery means of providing the new bar code or language to the user. Barcode can appear as a scroll, which can be scanned by a fixed scanner that has the barcode streaming by in a scroll that could be supplied by a rolled reserve spool of text and gathered up by a gathering spool much the same as a fax or typewriter ribbon. Further, for example, a new barcode for use in a computer in the format of CDs, DVDs, floppy disks, etc. can be provided. A fixed scanner can similarly be installed into the computer that can read the new barcode or language. Since the users typically are LV/B, translation into written language is of little value, since that is sight demanding technology, this invention deals largely with the text-to-speech technology and/or text-to-display from this new barcode language to English (i.e. the barcode is translated into English words, which are then spoken from the translating scanner corresponding to the words scanned and translated from the new Braille type barcode).

For example, the new barcode can be a variation of an existing bar code such as PDF 417, a matrix code, matrix barcode, two-dimensional matrix barcode (e.g. DataMatrix) or another so called 2-d barcode chosen because of its large capacity for characters, and thus capacity for a number of words, three-dimensional or higher dimensional barcode. This barcode can be modified to provide for this new capability, or a whole new barcode font and code can be created to provide for this capability of intellectual property protection. Another variation of the scanned new barcode text and scanner, can be used to “back up”, or index a verbalized word, and provide a definition of that particular word.

For example, a printer of the new barcode must be so programmed, process capable, and configured so as to be able to print the new barcode on pages as demonstrated above or in a variety of other positioning schemes relative to the various folds, shapes, layout etc., of the various legions of publications that exist. The new barcode can be printed in ink, which is not visible to the normal sighted eye and consequently the print needs to be equipped with an illumination device of a light wavelength that stimulates and makes visible the otherwise invisible printed new bar code for the purposes of inspection, verification of printing, and for other quality control purposes. These printers must be capable of interpretation of data to cause the written or electronic text to be properly encoded into the new barcode and printed in that manner.

### Cell Phone

A cell phone 700 is shown in FIGS. 1-4. The cell phone 700 is configured to read barcodes when positioned above the surface of a page (i.e. non-contact).

The cell phone 700 includes a display 702 (e.g. liquid crystal display) and an alphanumeric keypad 704 (e.g. standard layout). A digital camera 706 is configured for reading the barcode.

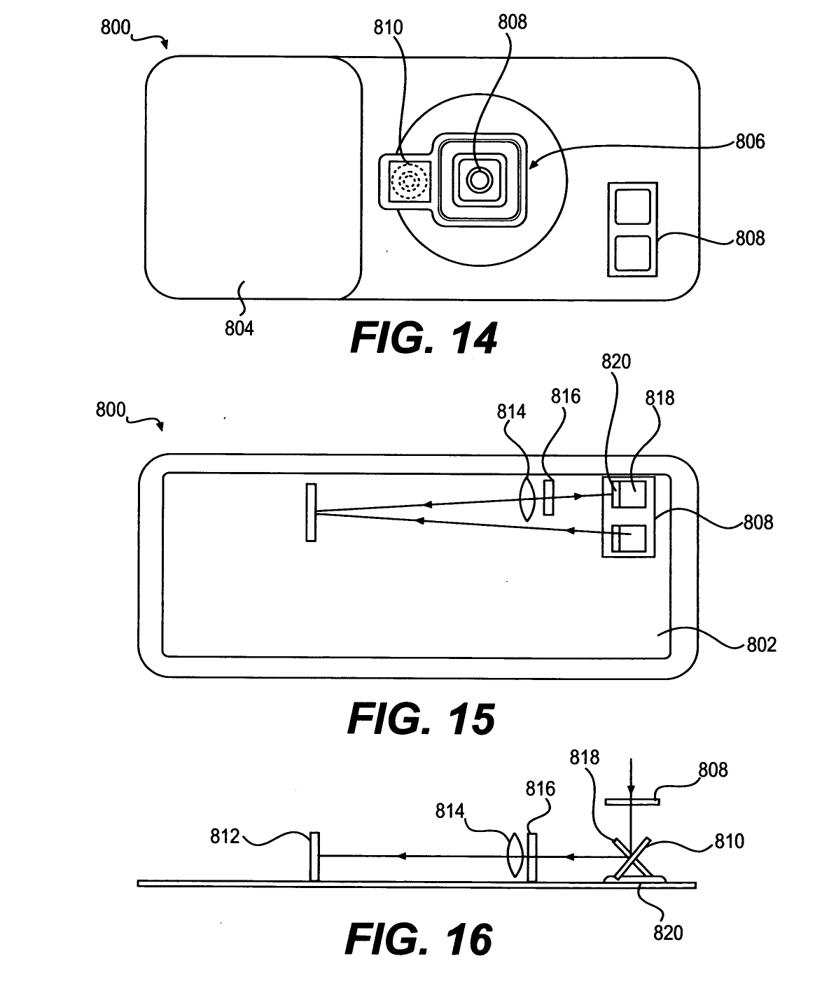

Another cell phone 800 is shown in FIGS. 14-16. The cell phone 800 is configured to read barcodes when positioned in “contact” with the surface of the page or document.

The cell phone 800 includes a display 802 (e.g. liquid crystal display) and an alphanumeric keypad 804 (e.g. standard layout). A digital camera 806 is configured for reading the barcode.

The cell phone 800 includes an optical window 808 for scanning barcode. As shown in FIGS. 15 and 16, the light entering through the optical window is reflected ninety degrees (90°) by mirrors 810 and 812. The light passes through a condensing lens 814 and illuminator ring 816, and then is reflected by mirror 818 onto light detector 820. The light detector 820 converts the barcode signal into an electronic signal.

The mirrors 810 and 812 are spaced apart to increase the focal length of the lens arrangement. The illuminator ring 816 adds light to illuminate the bar code, and enhance the barcode signal.

Alternatively, a separate optical lens illumination module system can be fitted over the digital camera 806 to significantly reduce the focal length of the digital camera 806.

The cell phone according can be based on a wide number of existing cell phones.

The cell phone can be perform as a harvesting device for collecting information throughout the office and outside world by scanning barcodes and wirelessly communicating the information embodied in the barcodes via a cellular network and/or Internet to the user's personal computer, computer server, personal computers of others, and computer network of an individual, business, institution,

### Barcode Mouse

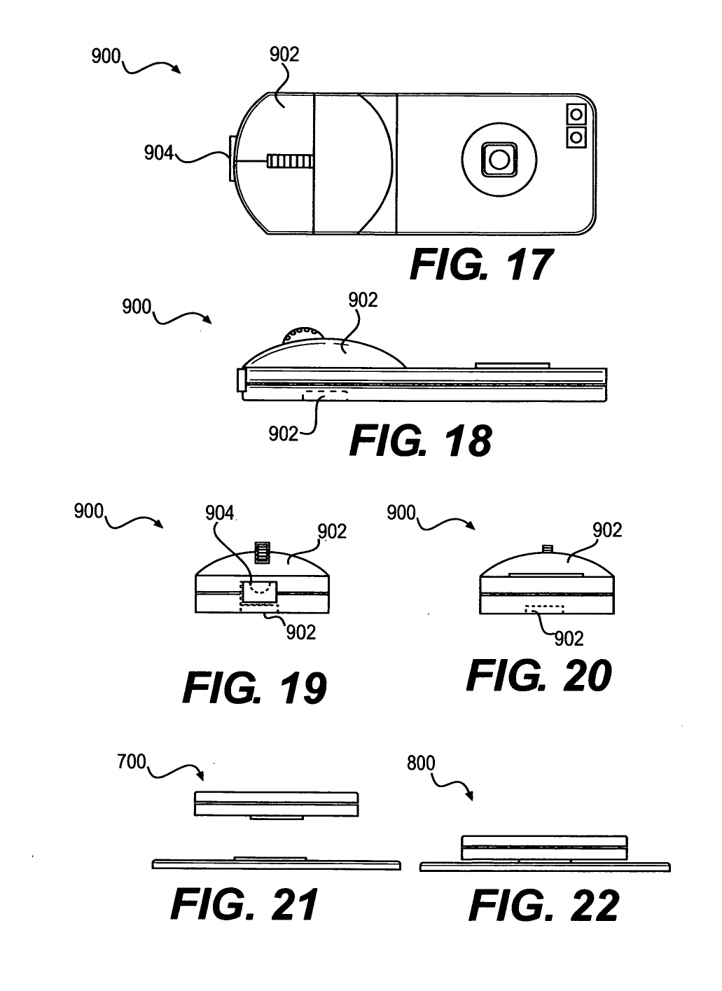

A bar code mouse 900 is shown in FIGS. 17-20.

The bar code mouse 900 is provided with a positioning device 902 to move a pointer on a computing device (e.g. personal computer, pad, cell phone, personal electronic device) display or screen. The mouse 900 can be configured to communicate with a computing device via a wire or wirelessly. The positioning device can be a conventional positioning ball or solid state light (e.g. laser) positioning arrangement.

The mouse 900 is provided with a barcode scanner 904 configured for scanning a barcode on a medium (e.g. paper, page, document) or displayed on a computer screen. The mouse 900 is configured to scan and read the barcode, and then convert the barcode into a digital signal that can be converted into another data format (e.g. text, display, illustration, picture, image, voice, speech, language). For example, the mouse can scan the barcode on a document and display the text of the document on the computer screen (e.g. WORD format). Further, for example, the mouse 900 can scan the barcode on the computer screen to bring up a page of text, file, website on the computer screen. A matrix of barcodes can be displayed on the screen at one time to allow the user to work on multiple pages, files, or websites by scanning the barcode to bring up a page, file, or website on the screen, and scanning another barcode to bring up the next page, file, or website on the screen.

Optionally, the mouse 900 can be configured to be a cell phone. For example, the mouse 900 can scan a barcode on the computer screen to communicate a document embodied or represented by the barcode wirelessly to another remote wireless electronic device via a cellular communication network and/or Internet.

### Additional Cell Phone Features

The cell phone can be configured to incorporate a number of features to enhance its use as a barcode cell phone.

For example, the cell phone is preferably configured to scan barcodes with 1 to 100,000 characters per square centimeter or 1 to 1,000,000 characters per cubic centimeter. Further, the cell phone is preferably configured to scan one-dimensional (1-D), two-dimension (2-D), three-dimension (3-D), and holographic barcodes.

The cell phone can include barcode illumination. Specifically, the cell phone is provided with one or more illumination device to illuminate the barcode when being scanned or when the cell phone takes a digital picture thereof. For example, the cell phone can be provided with an incandescence bulb, light emitting diode (LED), infrared emitter, or other suitable illumination device or devices.

Further, the cell phone can be provided with a zoom lens arrangement or configured to provide different focal length capabilities. Alternatively, a physical focal path lengthening spacing device and/or optical lens magnifying or minifying the focal distance device can be added to the cell phone. These optical path varying device, for example, can include telescoping sleeves, clip-on housings with mirrors to increase the optical path distances, holsters, or an add on housing, which can include additional illumination.

The cell phone is preferably concatenate capable, to string a plurality of barcodes together in context. Further, the cell phone with barcode scanning features include laser scanning and image capturing along with using a discreet 1-D code for image capture triggering.

The cell phone can be configured with fixed focus scanning, and variable/auto-focus scanning.

The cell phone can comprise one or more of the following additional features:
1) a cellphone with dictionary capabilities;
2) a cell phone with word look-up capabilities;
3) a cell phone with contact barcode scanning capabilities;
4) a cell phone with non-contact or distant barcode scanning capabilities;
5) a cell phone with the scanning lens located in a corner of the cell phone housing providing left and right page scanning capabilities;
6) a cell phone with contact scanning capabilities with a contact surface or surfaces of which is slightly elevated on runners or edges causing the scanner surface to be just above the scanned barcode, thus preserving the surface of the scanned code;
7) a cell phone with a rechargeable battery, ports, and USB access;
8) a cell phone with text to speech capabilities and software programs;
9) a cell phone with barcode scanning capabilities;
10) a cell phone with word look-up capabilities with scanned materials;
11) a cell phone with internet access;
12) a cell phone with internet access via barcode scanning;
13) a cell phone with multiple language capabilities;
14) a cell phone with multiple voice download capabilities;
15) a cell phone with dialect and accent download capabilities;
16) a cell phone with multiple font and language barcode generation capabilities;
17) a cell phone with texting to barcode generation capabilities in multiple languages;
18) a cell phone with solar recharging capabilities;
19) a cell phone that has kinetic recharge capabilities;
20) a cell phone that has a lenticular screen or lenticular overlay to generate 3-D screen images;
21) a cell phone having voice to text to barcode capabilities;
22) a cell phone capable of receiving barcode information converting that information into visible text or speech; and
23) a cellphone capable of converting speech to text to barcode to provide interactive communications in a texting format.

### Barcode Printers

A printer can be configured to print a barcode.

The barcode can have high resolution and features that require a high resolution printer to provide large information content within the barcode.

For example, the printer can be a dot matrix, inkjet, laser printer, or a commercial printer.

### Barcode Scanning

The cell phones can be configured to scan barcode in a non-contact manner (FIG. 21), or in a contact manner (FIG. 22). Alternatively, a near-contact or close barcode scanning can be achieved with a different lens and/or housing arrangement.

### Barcode Scanning Device (Knowsy™)

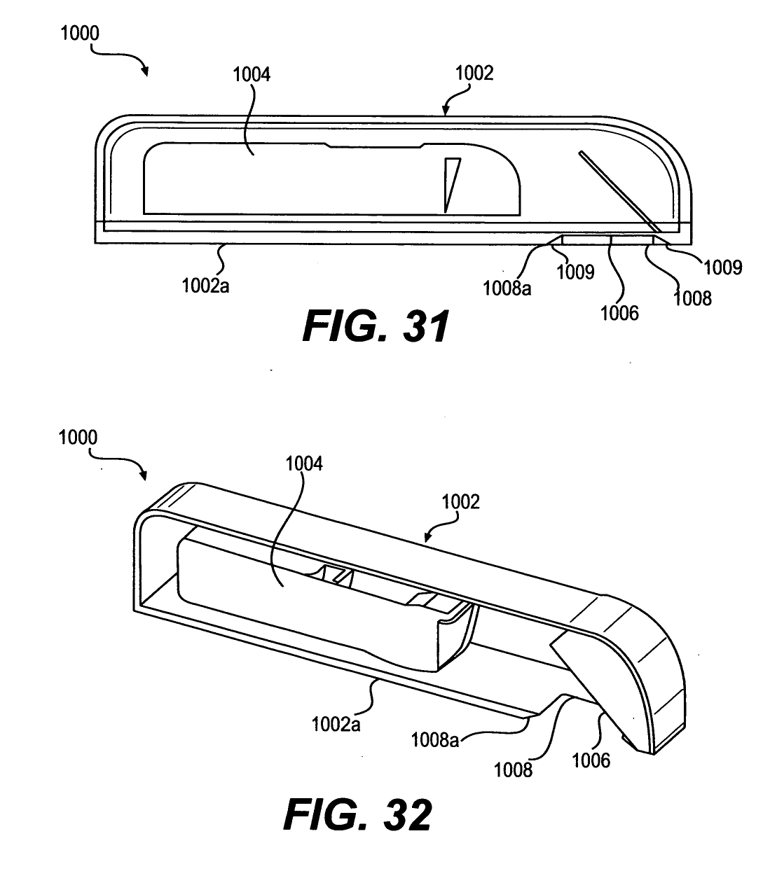

A barcode scanning device 1000 is shown in FIGS. 31 and 32. The barcode scanning device 1000 comprises a housing 1002 containing a digital camera 1004, reflecting mirror 1006, and window 1008 having tapered edges 1008a. The barcode scanning device 1000 is optionally provided with illumination devices 1009 (e.g. light emitting diodes) positioned adjacent the window 1008 and a power source (not shown)(e.g. battery(ies), rechargeable battery(ies)). The illumination devices 1009 are configured to illuminate the barcode to be scanned to enhance the scanning or reading capability of the barcode scanning device 1000.

The housing 1002 is placed in contact with the medium (e.g. page, document, surface) supporting a barcode. The image of the barcode is viewed through the window 1008, reflected by mirror 1006, and captured by the digital camera 1004. This arrangement changes the light path by ninety degrees (90%) to provide an orientation so that a bottom surface 1002a contacts the medium and allows sliding relative thereto during the barcode scanning operation using the barcode scanning device 1000. Specifically, a user grips the housing 1002 of the barcode scanning device 1000, and then moves the device 1000 in “contact” with the medium and/or barcode.

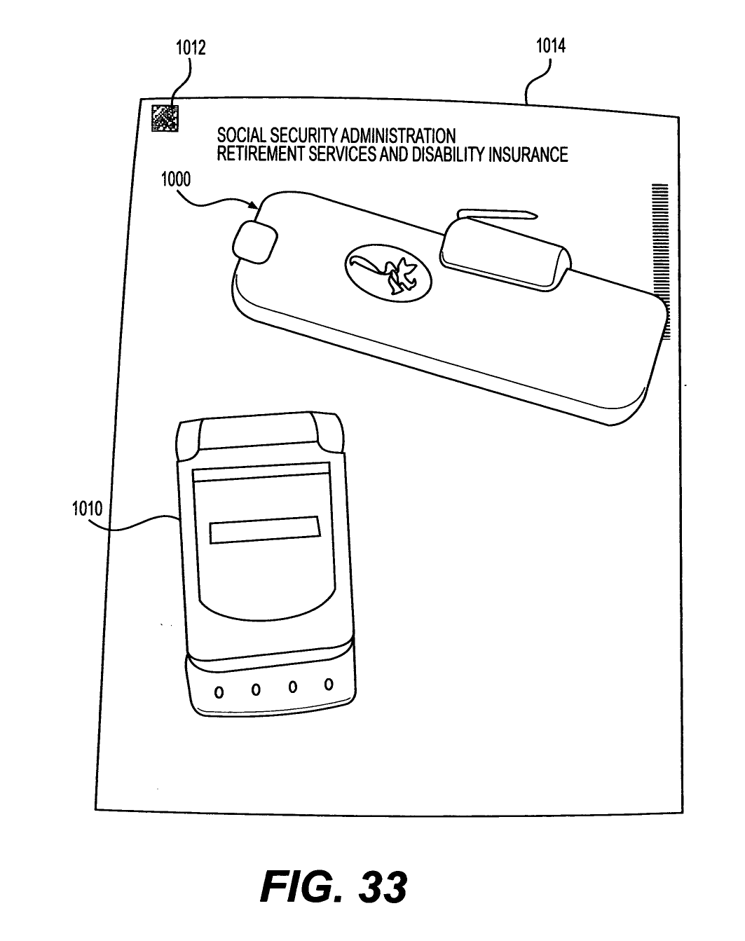

As shown in FIG. 33, the barcode scanning device 1000 is configured to wirelessly communicate with the cell phone 1010. The barcode scanning device 1000 is configured to scan the two-dimensional matrix barcode 1012 to generate an electronic barcode signal, and then wirelessly communicate the electronic barcode signal to the cell phone 1010. The cell phone 1010 is configured (e.g. hardware and/or software) to convert the scanned and transmitted electronic barcode signal into speech, voice, and/or display (e.g. text displayed on cell phone). In this example, the barcode 1012 contains the information (e.g. text) of the document 1014 as shown (i.e. Social Security Administration, Retirement Survivors and Disability Insurance letter).

### EXAMPLES

### Example #1

A cell phone manufactured by Nokia [N86] is configured to convert barcode into speech. The cell phone is provided with an automatic trigger to trigger the digital camera of the cell phone to take a digital image of a two-dimensional matrix barcode. The two-dimensional bar code and text are printed onto a document. The information content of the text is also contained in the two-dimensional barcode (i.e. the barcode is configured or coded with the text equivalent). The cell phone is positioned above the barcode on the document, and the cell phone begins taking the digital image of the barcode and converting the scanned barcode into speech.

### Example #2

A cell phone manufacturer by Nokia [N86 or 95] is configured to convert barcode into speech. The mode of the cell phone is switched to automatically trigger the digital camera when the cell phone is positioned over the barcode. A stylized filigree type bar code is printed onto stock material used to print money along with the numerical denomination and artwork of the bill. The simple denominating, stylized filigree or scroll barcode is provided with information content comprising the numerical denomination of the bill, the serial number of the bill, location of printing, date printed, security information. The cell phone is moved towards the barcode on the bill, and when the digital camera of the cell phone senses the barcode it automatically speaks the denomination of the bill. Alternatively, the scan window can be slotted such that the corner of the document or currency can be swiped through the slot exposing the encoded area.

### Example #3

A cell phone manufactured by Nokia [N95 8 GB] is configured to convert barcode into speech. A plastic laminate building sign is printed with alpha numeric information and a two-dimension matrix barcode. The building sign is mounted on the wall of a commercial building. The information content of the printed alpha numeric information of the sign is coded into the two-dimensional barcode. The information content, for example, comprises the building name, building address, building directory, building level, emergency information, emergency exit information, emergency telephone number, emergency fax number, emergency email address. A user locates the building sign in the building, and uses the digital camera of the cell phone to take a digital image of the barcode and speaks the information content to the user.

### Example #4

A cell phone manufactured by Nokia [N95 8 GB] is configured to convert barcode into speech. An elevator sign is printed with the floor number and a barcode configured or coded with the floor number. The elevator sign is positioned next to or part of the elevator button on a particular floor. A user locates the elevator button and uses the digital camera of the cell phone to take a digital image of the barcode and speaks the floor number.

### Example #5

A cell phone manufactured by Nokia [N86 8 MP] is configured to convert barcode into speech. An elevator having a control panel with floor buttons is provided inside the elevator. The floor buttons visually display the floor numbers. A plastic laminate printed with barcode configured or code with the floor number is mounted next to the floor buttons. A user scans the barcodes with the cell phone to identify the particular barcode and corresponding button for the floor selected by the user.

### Example #6

A user prints an envelope using a personal computer running Word program with a laser printer. The address and two-dimensional matrix barcode are configured or coded with the address printed on the envelope. A user takes a digital image of the barcode using the digital camera of the cell phone, which speaks the address. The postal service uses the barcode for sorting and routing mail to the appropriate address.

### Example #7

A food package is printed with brand name, marketing information, nutritional information, cooking instructions and a two-dimensional barcode configured or code with the visual information content. A user scans the barcode with a cell phone configured to convert the barcode into speech. The cell phone is configured with a button set or programmed to speak the product identification and a sequence of the other visual information content, for example, the price, price per ounce, number of ounces, nutritional content, flavor, number of units inside, brand name. Recipes may also be formatted in this manner

### Example #8

A book is printed with text and a two-dimensional matrix barcode on each page. The two-dimensional barcode comprises the information content of the text on the particular page. A user uses a cell phone manufactured by Nokia to takes a digital image of the barcode on a particular page and the cell phone speaks the text printed on that particular page.

### Example #9

The same as Example #8, however, the user is blind or low-vision. The user moves the cell phone on the surface of the page at a particular location until the cell phone senses the barcode, and then speaks the text printed on that particular page.

### Example #10

A book is printed with text and two (2) separate two-dimensional matrix barcodes on each page. One two-dimensional barcode comprises the information content of the text on the particular page (i.e. “text content barcode”). The other two-dimensional barcode comprises additional information or content, for example, footnote, cross-reference, advertisement, product, company, citation, reference, related books, related titles, related movies, trailers, related media, music, pictures, author, publisher, history, illustration, pictorial, data, equations, graphs information or content, and/or otherwise additional information or content directly relevant, indirectly relevant, or not relevant to the text printed on the particular page and/or the book (i.e. “additional information/content bar code”). A user takes a digital image of the “text content barcode” using a cell phone manufactured by Nokia, which speaks the text printed on that particular page. The user then takes a digital image of the “additional information/content barcode” to obtain further information or content. The additional information or content comprises a voice directory to allow a user to select particular additional information or content desired to be selectively disseminated by the voice. The additional information may also be music.

### Example #11

A book is printed with text and two (2) separate two-dimensional matrix barcodes on each page. One two-dimensional barcode comprises the information content of the text on the particular page. The other two-dimensional barcode comprises a hyperlink to the Internet to provide real time updated additional information or content, for example, footnote, cross-reference, advertisement, product, company, citation, reference, related books, related titles, related movies, trailers, related media, music, photographs, videos, author, publisher, history, illustration, pictorial, data, equations, graphs information or content, and/or otherwise additional information or content directly relevant, indirectly relevant, or not relevant to the text printed on the particular page or the book (i.e. “additional information/content bar code”). A user takes a digital picture of the “text barcode” using a cell phone manufactured by Nokia, which speaks the text. The user then takes a digital picture of the other barcode to be hyperlinked to one or more sites on the Internet to obtain further information or content.

### Example #12

A book is printed with text and three (3) separate two-dimensional matrix barcodes on each page. One two-dimensional barcode comprises the information content of the text on the particular page (i.e. “text barcode”). The second two-dimensional barcode comprises additional information or content, for example, footnote, cross-reference, advertisement, product, company, citation, reference, related books, related titles, related movies, trailers, related media, author, publisher, history, illustration, pictorial, data, equations, graphs information or content, and/or otherwise additional information or content directly, indirectly, or not relevant to the text printed on the particular page (i.e. “additional information/content bar code”). This additional information has a fixed content based on information available at the time of printing the book (i.e. “fixed content barcode”). The third two-dimensional barcode comprises a hyperlink to the Internet to provide real time updated additional information or content (i.e. “active content barcode”). A user takes a digital picture of the first barcode with a cell phone manufactured by Nokia on the particular page and the cell phone speaks the text printed on that particular page. The user then takes a digital picture of the second barcode to obtain additional fixed information or content, and/or takes a digital picture of the third barcode to obtain additional active information or content.

### Example #13

A book is printed with at least one page comprising multiple separate barcodes and pages of text. Each of the separate barcodes corresponds to a particular page of text in the book, and contains the information content of each particular page of text. A user uses a cell phone manufactured by Nokia to take a digital image of one of the barcodes listed on the at least one page of the book. The cell phone speaks the page number and the text on that particular page of the book. The user then takes a digital image of the next barcode, and the cell phone speaks the next page of text. Alternatively, the user swipes down the barcodes in a particular sequence at one time, and then the cell phone speaks the pages of text in the particular sequence swiped down by the user.

### Example #14

A page or document is printed with text and a two-dimensional matrix barcode comprising the information content of the text and pictorial or graphic information relating to the text. An illiterate user takes a digital picture of the barcode with a cell phone manufactured by Nokia, and the cell phone speaks the text while displaying the text and pictorial or graphic information relating to the text to help the illiterate user understand the text as he or she reads the text on the display of the cell phone to learn and become literate. The pictorial or digital information shown on the display of the cell phone can relate to the identity of people, animals, objects being discussed in the text, actions taken in the text, phonic information.

### Example #15

The same as Example #14, except the display of the cell phone displays the text, and highlights the words as being spoken by the cell phone so that the user can follow the words with the speech.

### Example #16

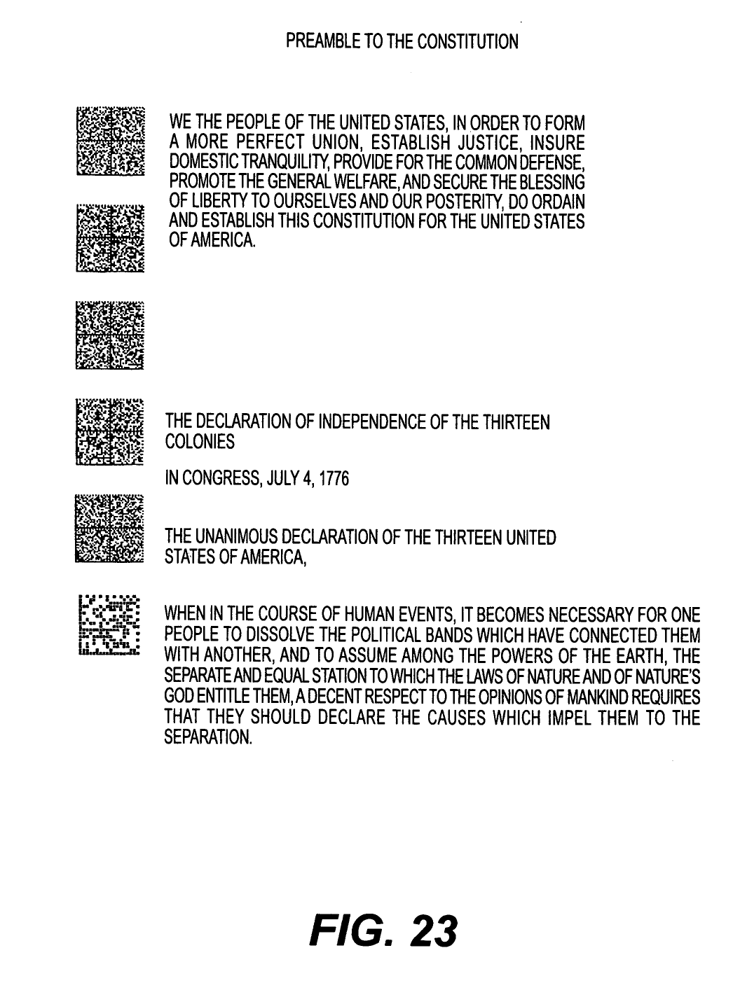

The Preamble to The Constitution with corresponding barcodes to be scanned and read by the cell phone according to the present invention, as shown in FIG. 23.

### Example #17

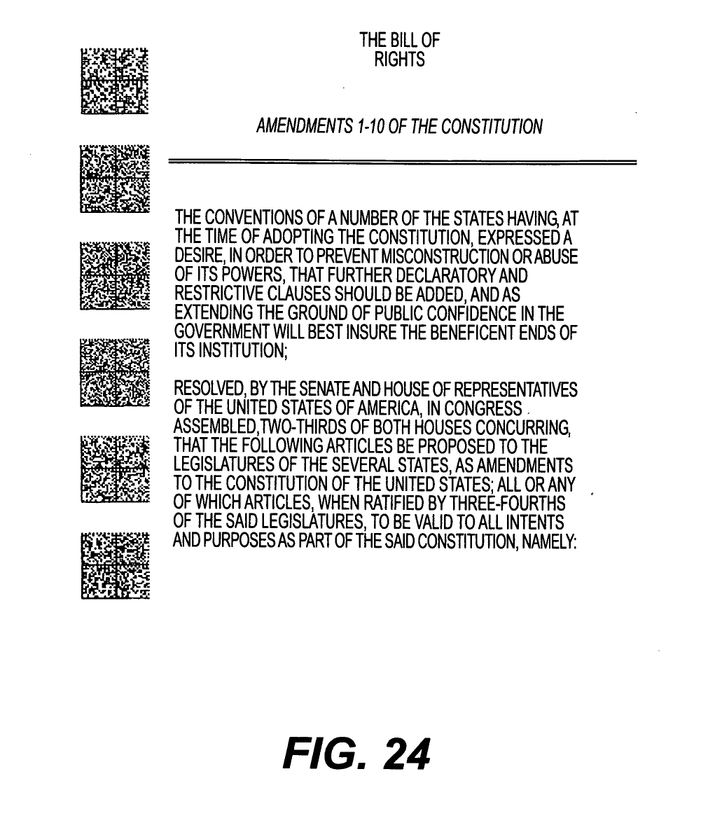

A portion of The Bill of Rights with corresponding barcodes to be scanned and read by the cell phone according to the present invention, as shown in FIG. 24.

### Example #18

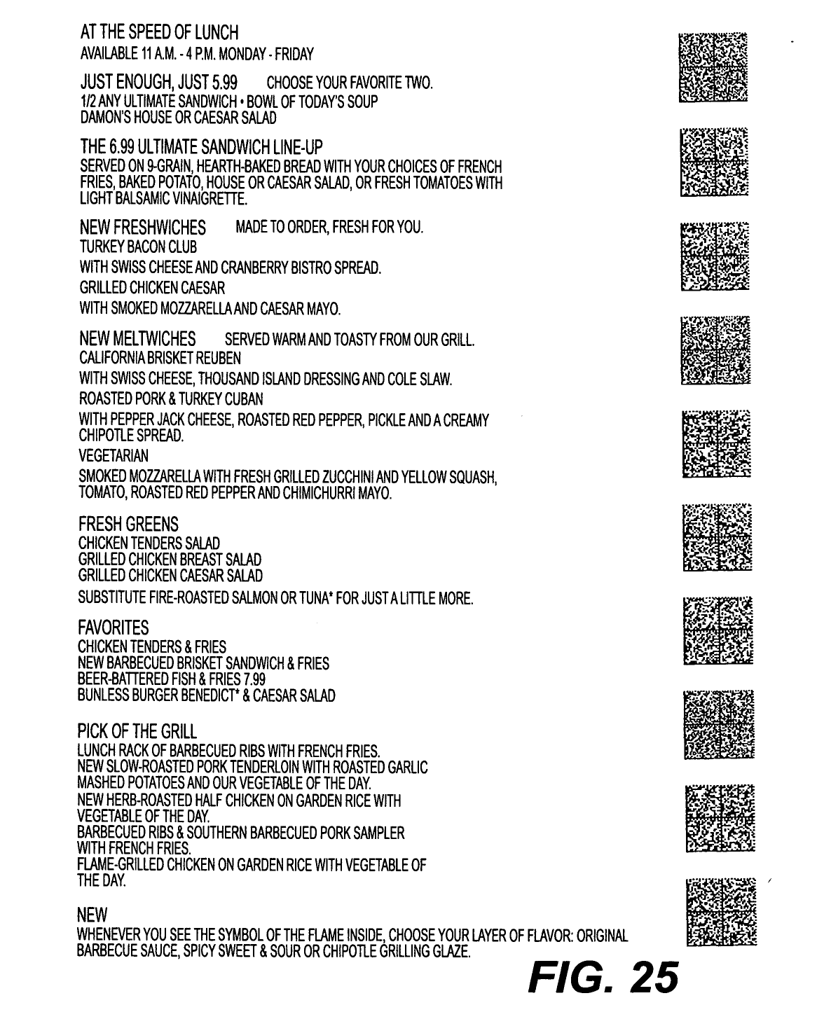

A sample menu with corresponding barcodes to be scanned and read by the cell phone according to the present invention, as shown in FIG. 25.

### Example #19

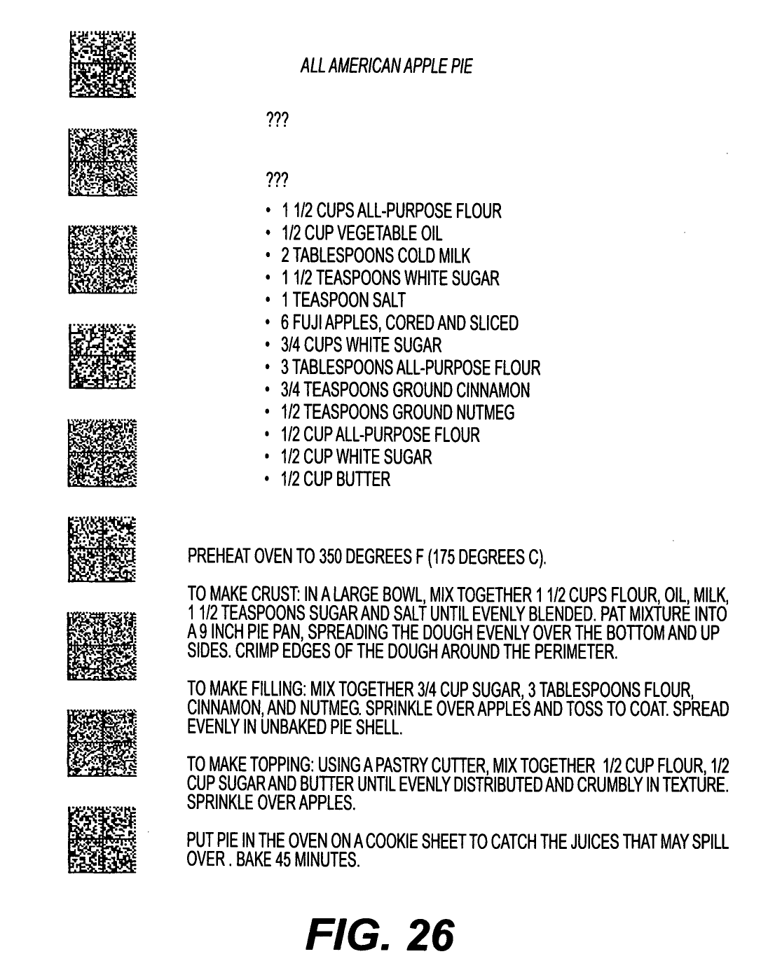

A sample recipe with corresponding barcodes to be scanned and read by the cell phone according to the present invention, as shown in FIG. 26.

### Example #20

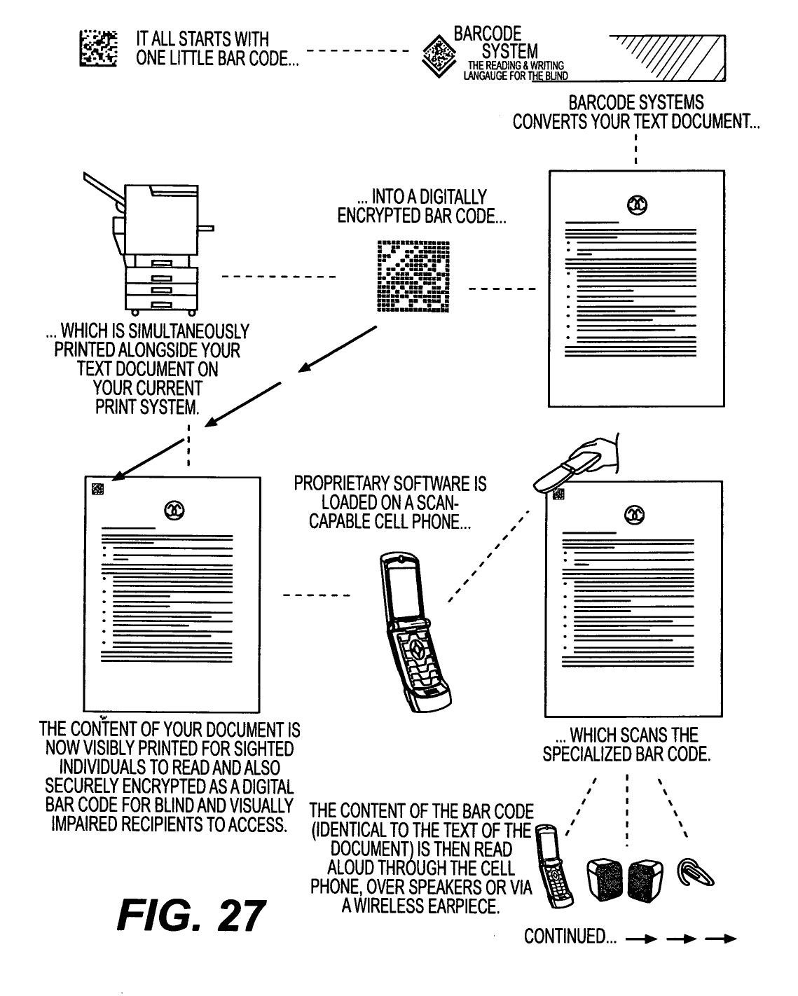

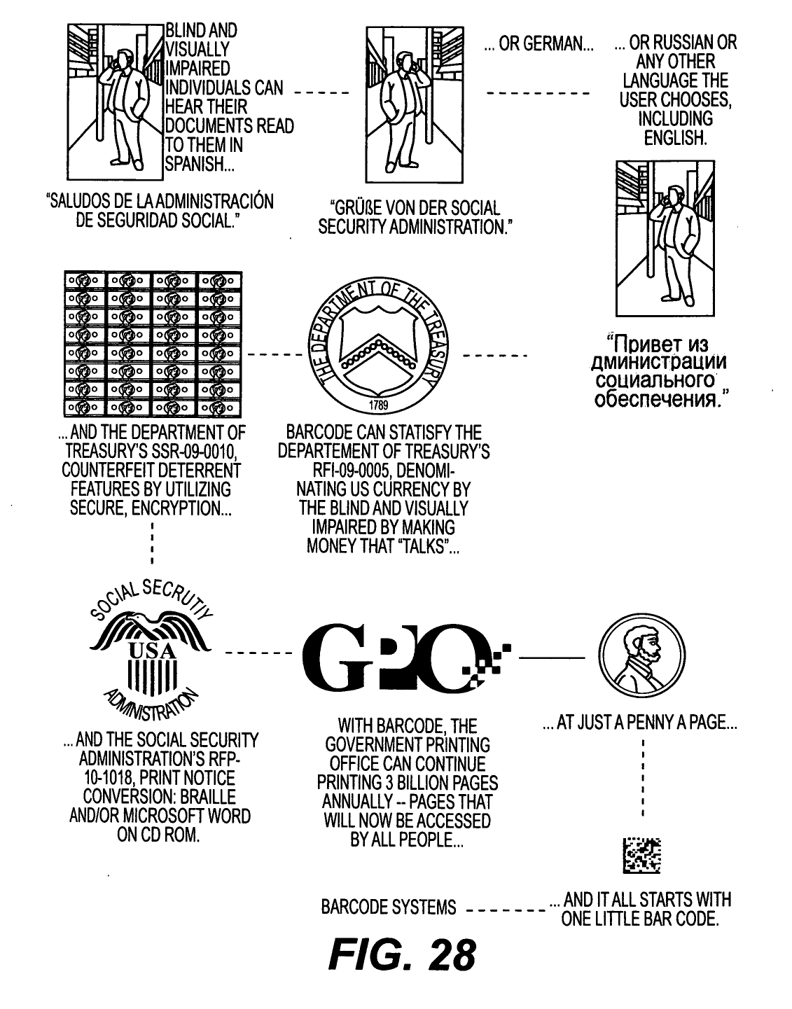

The barcode flow diagrams shown in FIGS. 27 and 28.

### Example #21

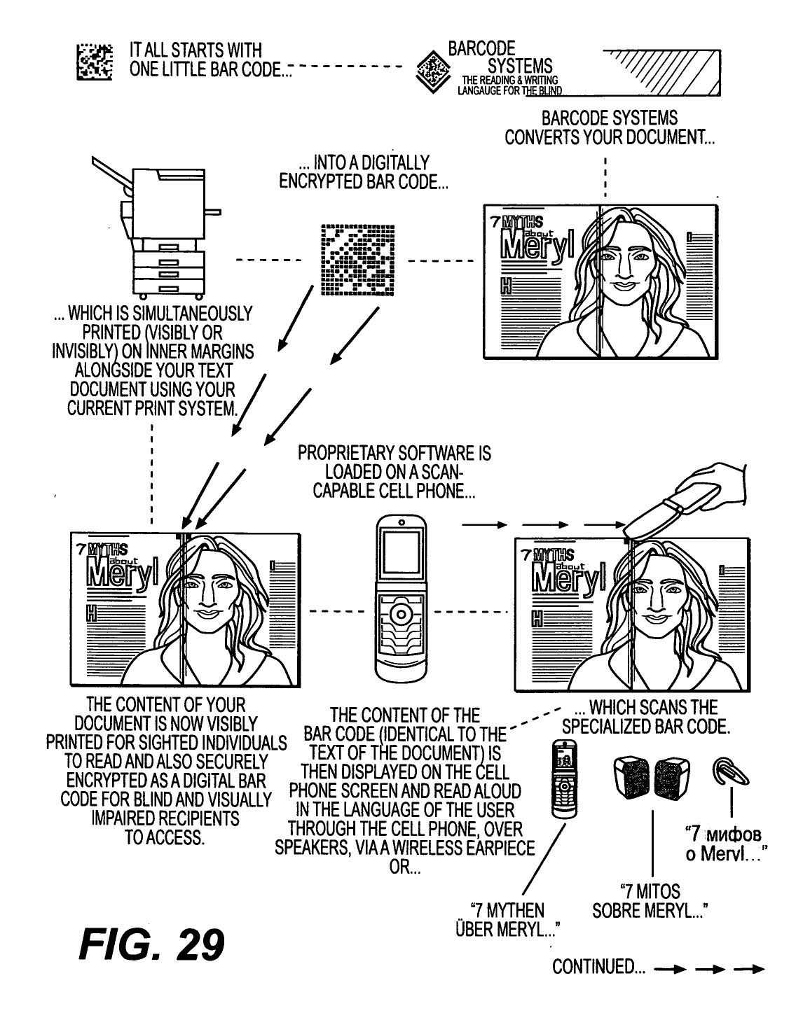

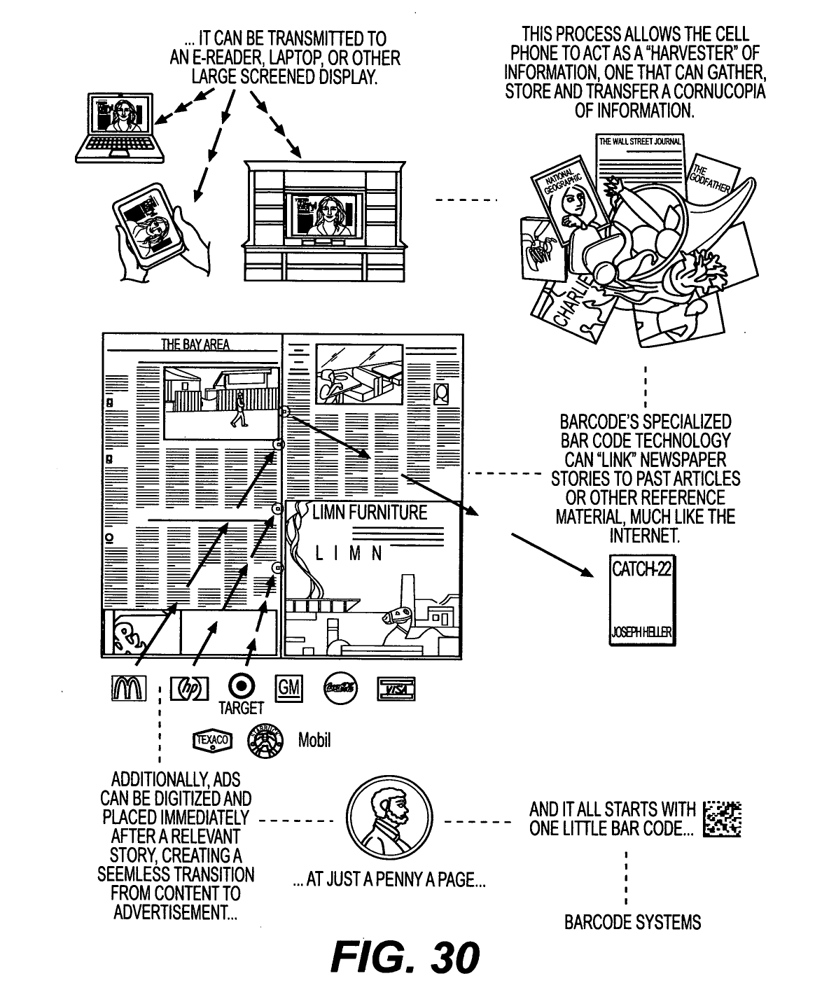

The barcode flow diagrams shown in FIGS. 29 and 30.

### Example #22

The barcode scanner shown in FIGS. 31 and 32 is an example of the Knowsy™ barcode scanning device.

### Example #23

The barcode scanner wirelessly connected to a cell phone shown in FIG. 33.

We claim:

1. A bar code device, the device comprising;
a cell phone; and
a bar code scanning device configured to scan a bar code and convert the bar code into an electronic signal and communicate the signal to the cell phone.

2. The device according to claim 1, wherein the bar code scanning device is configured to contact the bar code when scanning the bar code.

3. The device according to claim 1, wherein the bar code scanning device is configured to not contact the bar code when scanning the bar code.

4. The device according to claim 1, wherein the bar code scanning device is configured to near contact the barcode when scanning the bar code.

5. The device according to claim 1, wherein the bar code scanning device is an omni-directional bar code scanning device.

6. The device according to claim 1, wherein the barcode scanning device is configured to communicate wirelessly to the cell phone.

7. The device according to claim 1, wherein the barcode scanning device is configured to communicate via a wire to the cell phone.

8. The device according to claim 1, wherein the barcode scanning device is configured to scan a bar code and convert the bar code into an electronic barcode signal, and communicate with the cell phone, the cell phone configured to convert the electronic barcode signal into an electronic voice, speech, or language.

9. The device according to claim 1, wherein the cell phone is configured to wirelessly communicate with a computer.

10. The device according to claim 1, wherein the cell phone is configured to wirelessly communicate to a local area network (LAN).

11. The device according to claim 1, wherein the cell phone is configured as a computer mouse.

12. The device according to claim 10, wherein the computer mouse wirelessly communicates with a computer.

13. The device according to claim 10, wherein the computer mouse wirelessly communicates with a local area network.

14. The device according to claim 10, wherein the computer mouse wirelessly communicates with the Internet.

15. The device according to claim 1, wherein the bar code scanning device is configured to read a bar code when moving the device relative to the bar code.

16. The device according to claim 1, wherein the bar code scanning device comprises a lens system for enhancing the scanning capability of the barcode scanning device.

17. The device according to claim 1, wherein the bar code scanning device comprises an illumination device configured to illuminate the barcode when scanning same.

18. The device according to claim 1, further comprising a printer configured to wirelessly communicate with the bar code scanning device or cell phone.

19. The device according to claim 1, wherein the barcode scanning device is configured to generate an electronic information signal containing the information content of the scanned barcode, and the communicate the electronic information with another the electronic device or system.

20. The device according to claim 1, wherein the barcode scanning device comprises a digital camera and at least one reflecting mirror.
